(19) United States
(12) Patent Application Publication
(10) Pub. No.: US 2012/0002923 A1
(43) Pub. Date: Jan. 5, 2012

(54) SIGNAL TRANSMISSION DEVICE AND MANUFACTURING METHOD THEREFOR

(75) Inventors: Yoshiaki Nakano, Tokyo (JP); Xueliang Song, Tokyo (JP); Foo Cheong Yit, Tokyo (JP); Shurong Wang, Tokyo (JP); Katsumasa Horiguchi, Tokyo (JP)

(73) Assignees: The University of Tokyo, Tokyo (JP); Advanced Photonics, Inc., Tokyo (JP)

(21) Appl. No.: 13/256,802

(22) PCT Filed: Mar. 17, 2010
(86) PCT No.: PCT/JP2010/054496

§ 371 Date: Sep. 15, 2011

(30) Foreign Application Priority Data
Mar. 17, 2009 (JP) 2009-065271

(51) Int. Cl. G02B 6/26; B23P 11/00

(52) U.S. Cl. 385/38; 29/428

(57) ABSTRACT

There are provided a signal transmission device capable of improving a production efficiency and reducing a production cost, and a manufacturing method thereof. A spacer 4 is interposed between peripheral surface portions 101a of optical waveguides 101 exposed by an optical waveguide exposure section 5 and a rear surface 115 of an optical module substrate 105. A height of the spacer 4 alone allows an optical element 103 of the optical module substrate 105 to be positioned so high that this optical element 103 can actually face optical waveguide end surfaces 109. Therefore, it is not required that the spacer be individually manufactured per signal transmission device. Further, there can be avoided individual length measurements of distances such as a distance L2 between a surface 2a of a base platform 2 and the peripheral surface portions 101a of the optical waveguides 101, or the like. In this way, not only the production efficiency can be improved, the production cost can also be reduced in a sense that neither length measurement steps nor length measurement instruments are required.

### TECHNICAL FIELD

The present invention relates to a signal transmission device and a manufacturing method therefor. Particularly, the present invention is suitable for use in a signal transmission device such as an optical communication device, an optical router device or the like.

### BACKGROUND ART

Conventionally, there has been known, for example, a signal transmission system enabling high-speed data transmission by means of optical signals transmitted and received by: a signal transmitting device comprising an optical transmitting element such as a laser diode or the like; and a signal receiving device comprising an optical receiving element such as a photodetector or the like, respectively. According to such signal transmitting device and signal receiving device (simply and collectively referred to as signal transmission devices hereunder), there are used optical signals with significantly less inter-signal interference than electrical signals, thereby allowing optical waveguides with widths dramatically shorter than those of electrical waveguides to be used, thus making it possible to further densely align signal transmission paths. Further, as such a kind of signal transmission device, there has also been disclosed a signal transmission device 100 comprising optical waveguides 101 embedded in a base platform 102, such optical waveguides 101 allowing optical signals to travel therethrough (e.g., patent document 1), as shown in FIG. 26(A) and FIG. 26(B) which is a sectional view taken on line W1-W1′ of FIG. 26(A).

In fact, this signal transmission device 100 is composed of: the base platform 102 having a plurality of the optical wave guides 101 embedded therein (symbols “ . . . ” in FIG. 26(A) represent optical waveguides omitted); and an optical module substrate 105 including an optical transmitting element or an optical receiving element 103 (simply and collectively referred to as an optical element hereunder) and an IC (Integrated Circuit) 104. The optical module substrate 105 is positioned to the corresponding base platform 102 by means of guide pins 111.

Here, the base platform 102 is, for example, made of an epoxy resin, and allows light to be trapped in the optical waveguides 101 made of a polymer resin. In fact, there are linearly provided in the base platform 102 the plurality of the optical waveguides 101 parallel to a width direction x orthogonal to a thickness direction z. Further, there is formed on a surface of the base platform 102 a concave section 107 of a rectangular parallelepiped shape by partially routering the base platform 102. Furthermore, a side surface portion 108 of the concave section 107 thus formed exposes end surfaces 109 of the optical waveguides 101 (simply referred to as optical waveguide end surfaces hereunder). As shown in FIG. 27 which is a sectional view taken on line W2-W2′ of FIG. 26(B), the plurality of the optical waveguides 101 in the base platform 102 are formed into rectangular columns, and are all positioned so high that they can face and be optically coupled with the optical element 103. As shown in FIG. 26(A) and FIG. 26(B), a pair of guide pin through holes 110 is separately provided on both sides of the optical waveguides 101, such guide pin through holes 110 longitudinally passing through the base platform 102 and allowing the rod-shaped guide pins 111 to be inserted therethrough.

Meanwhile, there are provided on a rear surface 115 of the optical module substrate 105 the IC 104 and a supporting portion 113 supporting the optical element 103. Particularly, the IC 104 is provided on an area facing the concave section 107 of the base platform 102, and the supporting portion 113 allows the optical element 103 to face the optical waveguide end surfaces 109 with a gap ΔL1 provided therebetween. Further, there are bored on the optical module substrate 105 guide pin through holes 114 corresponding to the guide pin through holes 110 of the base platform 102, said guide pin through holes 114 longitudinally passing through the optical module substrate 105 and allowing the guide pins 111 to be inserted therethrough. In this way, according to the signal transmission device 100, the optical module substrate 105 is mounted on the base platform 102 with a spacer 116 being further interposed therebetween, and with the guide pin through holes 110 of the base platform 102 being matched to the guide pin through holes 114 of the optical module substrate 105.

Further, according to the signal transmission device 100, guide pins 111 are then inserted through the guide pin through holes 110 and the guide pin through holes 114 thus matched so as to allow the optical module substrate 105 to be positioned to the base platform 102 and further jointed thereto by means of a plurality of joining materials 117 (e.g., solder, adhesive material) provided in advance. Particularly, the guide pins 111 thus arranged in a depth direction y as well as the width direction x orthogonal to the depth direction y, allow the optical element 103 to face the optical waveguide end surfaces 109 with the gap ΔL1 provided therebetween, such optical waveguide end surfaces 109 being exposed in the concave section 107 of the base platform 102.

Furthermore, the spacer 116 interposed between a surface 102a of the base platform 102 and the rear surface 115 of the optical module substrate 105, serves to adjust distances in the thickness direction z orthogonal to both the width direction x and the depth direction y, thus allowing the optical element 103 and the optical waveguide end surfaces 109 to face and be optically coupled with one another (simply referred to as optical coupling hereunder). In fact, a length measurement instrument not shown is at first used to measure a distance L1 between the rear surface 115 of the optical module substrate 105 and a light emitting or a light receiving region of the optical element 103, when using the spacer 116 to position the optical element 103 to the optical waveguide end surfaces 109 in the thickness direction z. Subsequently, the length measurement instrument not shown is further used to measure a distance L2 between the surface 102a of the base platform 102 and peripheral surface portions 101a of the optical waveguides 101.

The distance L1 between the rear surface 115 of the optical module substrate 105 and the light emitting or the light receiving region of the optical element 103, has to be equal to a combined distance of: the distance L2 between the surface 102a of the base platform 102 and the peripheral surface portions 101a of the optical waveguides 101; a distance L3 between the rear surface 115 of the optical module substrate 105 and the surface 102a of the base platform 102; and a distance L4 between the peripheral surface portions 101a of the optical waveguides 101 and centers of the optical waveguides 101. The spacer 116 of the same length as the aforementioned distance L3 is then prepared and interposed between the surface 102a of the base platform 102 and the rear surface 115 of the optical module substrate 105.

In this way, the signal transmission device 100 allows the optical element 103 and the optical waveguide end surfaces 109 to be optically coupled with one another in a sense that the optical element 103 can reliably receive optical signals transmitted from the optical waveguides 101 when the optical element 103 is an optical receiving element, and that the optical element 103 allows optical signals outputted therefrom to be reliably transmitted through the optical waveguides 101 when the optical element 103 is an optical transmitting element.

### REFERENCES

Patent document 1: WO2007/114384A1

### DISCLOSURE OF THE INVENTION

### Problem to be Solved by the Invention

According to the aforementioned signal transmission device 100, there can be consistently and precisely reproduced the distance L1 between the rear surface 115 of the optical module substrate 105 and the light receiving or the light emitting region of the optical element 103. However, the distance L2 between the surface 102a of the base platform 102 and the peripheral surface portions 101a of the optical waveguides 101, may erroneously vary per production. The reason for that is because the base platform 102 is manufactured by bonding together layers by means of an adhesive agent or the like, according to steps of manufacturing an FR4 printed board (glass-epoxy substrate). Specifically, a thickness of each one of these layers (especially the layer corresponding to the distance L2 between the surface 102a of the base platform 102 and the peripheral surface portions 101a of the optical waveguides 101) and a thickness of the adhesive agent may erroneously vary. Namely, according to the signal transmission device 100, there has to be prepared, per production, the spacer 116 exactly matched to the distance L3 between the surface 102a of the base platform 102 and the rear surface 115 of the optical module substrate 105, thus resulting in a significantly unfavorable production efficiency in terms of mass productivity and parts inventory control.

Further, according to the signal transmission device 100, a length measurement instrument has to be used, per production, to measure: the distance L1 between the rear surface 115 of the optical module substrate 105 and the light receiving or the light emitting region of the optical element 103; and the distance L2 between the surface 102a of the base platform 102 and the peripheral surface portions 101a of the optical waveguides 101, thus requiring due steps of performing the corresponding length measurements and incurring costs pertaining thereto.

In view of the aforementioned problems, it is an object of the present invention to provide a signal transmission device capable of improving a production efficiency and reducing a production cost, and a manufacturing method thereof.

### Means for Solving the Problem

In order to solve the aforementioned problems, the invention according to a first aspect of the present invention is a signal transmission device comprising: a base platform exposing end surfaces of optical waveguides formed internally and allowing optical signals to travel therethrough; and an optical module substrate having a rear surface facing a surface of the base platform and having an optical element provided on such rear surface for transmitting or receiving the optical signals, in which the end surfaces of the optical waveguides and the optical element face and are optically coupled with each other, and in which the base platform further comprises: an optical waveguide exposure section exposing peripheral surface portions of the optical waveguides on the surface; and a spacer interposed between the peripheral surface portions of the optical waveguides exposed by the optical waveguide exposure section and the rear surface of the optical module substrate, and allowing the optical element to be positioned so high that the optical element can face the end surfaces of the optical waveguides.

Further, according to a second aspect of the present invention, the peripheral surface portions of the optical waveguides formed internally in the base platform are unexposed in an area ranging from the end surfaces of the optical waveguides to the optical waveguide exposure section.

Furthermore, according to a third aspect of the present invention, the spacer is made of a material harder than materials forming the base platform and the optical waveguides, and the end surfaces of the optical waveguides are formed on a same plane as that of a side surface of the spacer.

Furthermore, according to a fourth aspect of the present invention, the signal transmission device further comprises: a supporting portion supporting the optical element and joined, along with an upper portion of the spacer, to the rear surface of the optical module substrate through a joining material; and a receiving space provided on the side surface of the spacer formed on a same plane as that of the end surfaces of the optical waveguides, such receiving space receiving excessive portions of the joining material protruding from joint locations of the supporting portion and the spacer.

Furthermore, according to a fifth aspect of the present invention, at least one of the base platform and the optical module substrate has guide pin through holes bored thereon, and the spacer is provided with guide pins inserted through the guide pin through holes of either the base platform or the optical module substrate so as to allow the spacer to be positioned to either the base platform or the optical module substrate.

The invention according to a sixth aspect of the present invention is a manufacturing method of a signal transmission device composed of: a base platform exposing end surfaces of optical waveguides formed internally and allowing optical signals to travel therethrough; and an optical module substrate having a rear surface facing a surface of the base platform and having an optical element provided on such rear surface for transmitting or receiving the optical signals, in which the end surfaces of the optical waveguides and the optical element face and are optically coupled with each other. Particularly, this manufacturing method comprises: an exposure section formation step for forming an optical waveguide exposure section exposing peripheral surface portions of the optical waveguides on the surface of the base platform; and a spacer mounting step for interposing a spacer between the peripheral surface portions of the optical waveguides exposed by the optical waveguide exposure section and the rear surface of the optical module substrate, such spacer allowing the optical element to be positioned so high that the optical element can face the end surfaces of the optical waveguides.

Further, according to a seventh aspect of the present invention, the exposure section formation step allows the peripheral surface portions of the optical waveguides formed internally in the base platform to be unexposed in an area ranging from the end surfaces of the optical waveguides to the optical waveguide exposure section.

Furthermore, according to a eighth aspect of the present invention, the manufacturing method further comprises a processing step following the spacer mounting step, for forming the end surfaces of the optical waveguides on a same plane as that of a side surface of the spacer, such spacer mounted in the spacer mounting step being made of a material harder than materials forming the base platform and the optical waveguides.

Furthermore, according to a ninth aspect of the present invention, the spacer mounted in the spacer mounting step has a receiving space formed on the side surface thereof provided on a same plane as that of the end surfaces of the optical waveguides, such receiving space receiving excessive portions of a joining material protruding from joint locations of a supporting portion supporting the optical element and the spacer when the supporting portion and an upper portion of the spacer are joined to the rear surface of the optical module substrate through the joining material.

Furthermore, according to a tenth aspect of the present invention, the manufacturing method further comprises a boring step prior to the spacer mounting step, for boring guide pin through holes on at least one of the base platform and the optical module substrate, such spacer mounting step mounting the spacer having guide pins capable of being inserted through the guide pin through holes of either the base platform or the optical module substrate, thus allowing the spacer to be positioned to the base platform or the optical module substrate through the guide pins in the spacer mounting step.

### EFFECTS OF THE INVENTION

According to the signal transmission device of the first aspect and the manufacturing method of the sixth aspect, a spacer is interposed between peripheral surface portions of optical waveguides exposed by an optical waveguide exposure section and a rear surface of an optical module substrate. A height of the spacer alone allows an optical element of the optical module substrate to be positioned so high that this optical element can actually face optical waveguide end surfaces. Therefore, it is not required that the spacer be individually manufactured per signal transmission device. Further, there can be avoided individual length measurements of distances including a distance between a surface of a base platform and the optical waveguides. In this way, not only a production efficiency can be improved, a production cost can also be reduced in a sense that neither length measurement steps nor length measurement instruments are required.

Further, according to the signal transmission device of the second aspect and the manufacturing method of the seventh aspect, the peripheral surface portions of the optical waveguides are partially unexposed, thereby allowing smooth optical waveguide end surfaces to be formed without causing potential loss in the peripheral surface portions of the optical waveguides during a polishing process.

Furthermore, according to the signal transmission device of the third aspect and the manufacturing method of the eighth aspect, the optical waveguide end surfaces are formed with respect to a side surface of the spacer, thus preventing the locations of the optical waveguide end surfaces from varying due to the polishing process per production.

Furthermore, according to the signal transmission device of the fourth aspect and the manufacturing method of the ninth aspect, a receiving space serves to receive excessive portions of a joining material protruding from joint locations at which a supporting portion and the spacer are joined to the optical module substrate.

Furthermore, according to the signal transmission device of the fifth aspect and the manufacturing method of the tenth aspect, the spacer can be precisely positioned in the optical waveguide exposure section by inserting guide pins into guide pin through holes.

### BRIEF DESCRIPTION OF THE DRAWINGS

FIG. 1 is a set of diagrams showing a top surface structure and a side sectional structure of a signal transmission device of a first embodiment of the present invention.

FIG. 2 is a diagram showing a vertical sectional structure of the signal transmission device of the first embodiment.

FIG. 3 is a set of diagrams provided to describe a manufacturing method (1) of a base platform of the first embodiment.

FIG. 4 is a set of diagrams provided to describe a manufacturing method (2) of the base platform of the first embodiment.

FIG. 5 is a set of diagrams provided to describe a manufacturing method (3) of the base platform of the first embodiment.

FIG. 6 is a set of diagrams showing a top surface structure and a side sectional structure of a signal transmission device of a second embodiment.

FIG. 7 is a diagram showing a vertical sectional structure of the signal transmission device of the second embodiment.

FIG. 8 is a set of diagrams provided to describe a manufacturing method (1) of a base platform of the second embodiment.

FIG. 9 is a set of diagrams provided to describe a manufacturing method (2) of the base platform of the second embodiment.

FIG. 10 is a set of diagrams provided to describe a manufacturing method (3) of the base platform of the second embodiment.

FIG. 11 is a set of diagrams provided to describe a manufacturing method (4) of the base platform of the second embodiment.

FIG. 12 is a set of diagrams provided to describe a manufacturing method (5) of the base platform of the second embodiment.

FIG. 13 is a set of diagrams showing a top surface structure and a side sectional structure of a signal transmission device of a third embodiment.

FIG. 14 is a diagram showing a vertical sectional structure of the signal transmission device of the third embodiment.

FIG. 15 includes a diagram showing a top surface structure of a spacer mounting jig and a perspective view showing how the spacer mounting jig is settled with respect to the base platform.

FIG. 16 is a side sectional view showing how a spacer is mounted on the base platform by means of the spacer mounting jig.

FIG. 17 includes a diagram showing a top surface structure of a spacer mounting jig of an other embodiment and a perspective view showing how this spacer mounting jig is settled with respect to the base platform.

FIG. 18 is a side sectional view showing how the spacer is mounted on the base platform by means of this spacer mounting jig.

FIG. 19 is a set of diagrams showing a top surface structure and a side sectional structure of a signal transmission device of a fourth embodiment.

FIG. 20 is a series of diagrams showing a structure of a pin-equipped spacer.

FIG. 21 is a set of diagrams provided to describe a manufacturing method (1) of a base platform of the fourth embodiment.

FIG. 22 is a set of diagrams provided to describe a manufacturing method (2) of the base platform of the fourth embodiment.

FIG. 23 is a set of diagrams provided to describe a manufacturing method (3) of the base platform of the fourth embodiment.

FIG. 24 is a diagram showing a side sectional structure of a signal transmission device of a fifth embodiment.

FIG. 25 is a series of diagrams showing a structure of a pin-equipped spacer of an other embodiment.

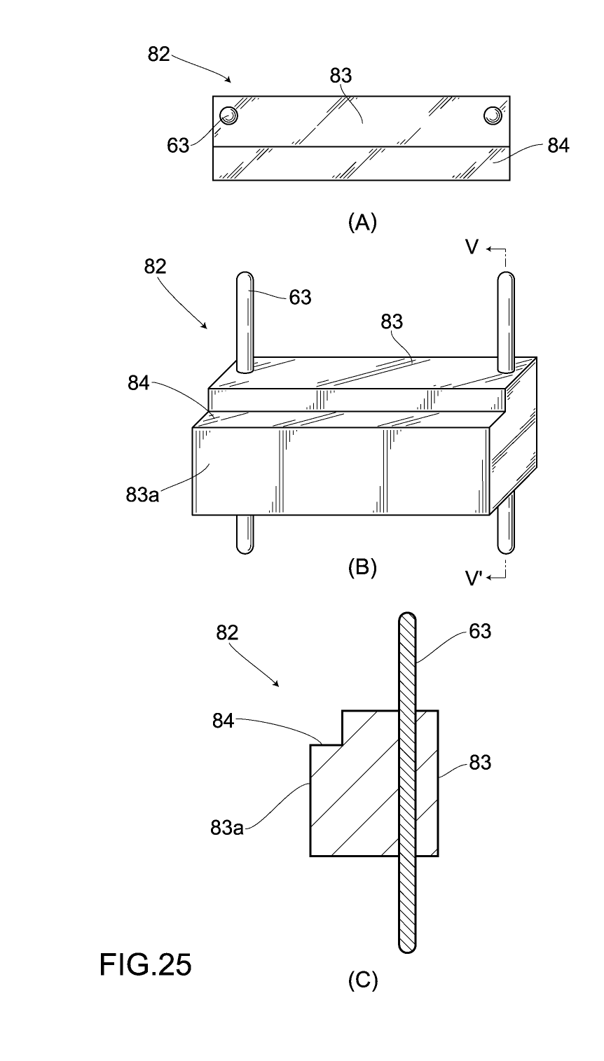

FIG. 26 is a set of diagrams showing a top surface structure and a side sectional structure of a conventional signal transmission device.

FIG. 27 is a diagram showing a vertical sectional structure of the conventional signal transmission device.

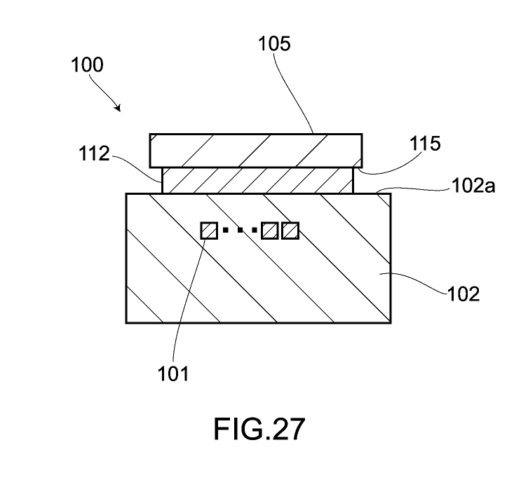

### BEST MODE FOR CARRYING OUT THE INVENTION

Embodiments of the present invention are described hereunder with reference to the accompanying drawings.

### (1) First Embodiment

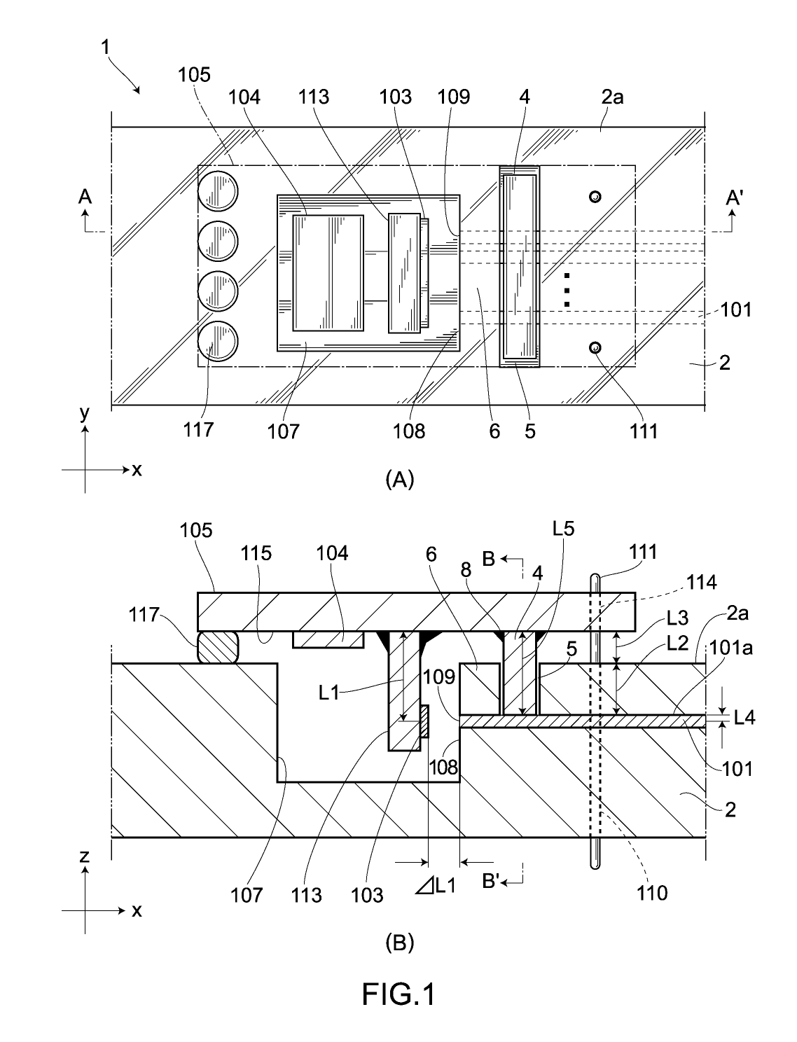

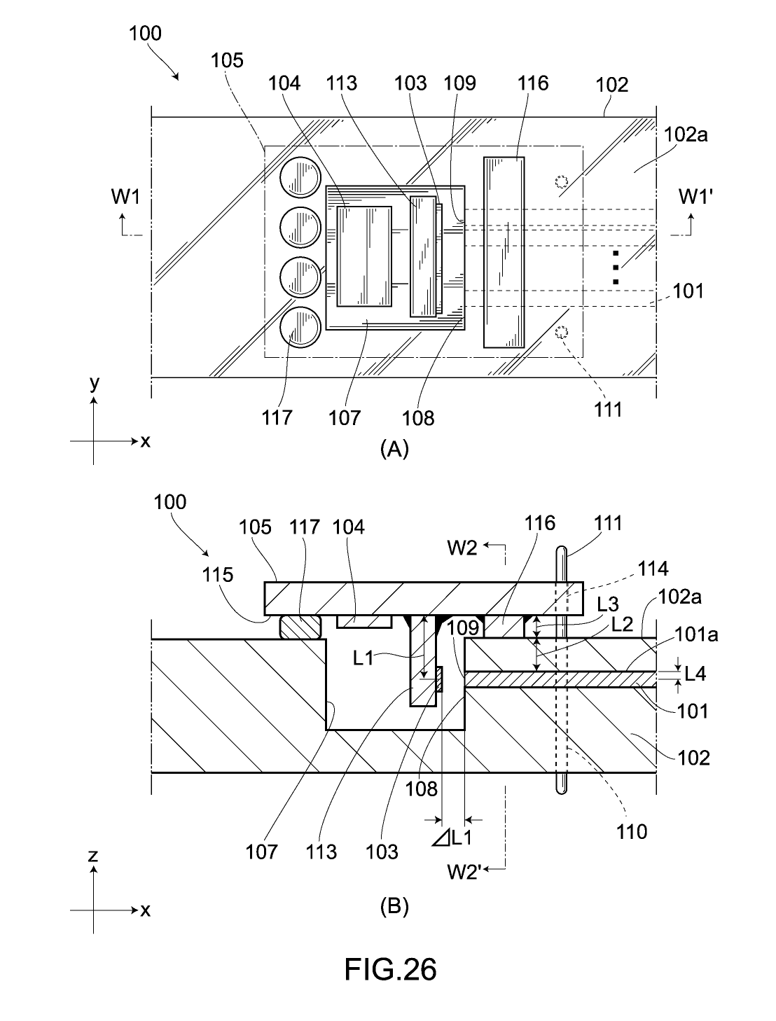

In FIG. 1(A) and FIG. 1(B), a symbol “1” represents a signal transmission device of a first embodiment of the present invention. Here, elements in FIG. 1(A) and FIG. 1(B) and corresponding elements in FIG. 26(A) and FIG. 26(B), share identical symbols. As shown in FIG. 1(A) and FIG. 1(B) which is a sectional view taken on line A-A′ of FIG. 1(A), the signal transmission device 1 has an optical waveguide exposure section 5 exposing peripheral surface portions 101a of optical waveguides 101 on a surface 2a of a base platform 2. A spacer 4 is further mounted in the optical waveguide exposure section 5.

The spacer 4 mounted in the optical waveguide exposure section 5 is interposed between the peripheral surface portions 101a of the optical waveguides 101 and a rear surface 115 of an optical module substrate 105. Further, the spacer 4 allows an optical element 103 to be positioned so high that the optical element 103 can actually face optical waveguide end surfaces 109. Particularly, according to the signal transmission device 1, the spacer 4 allows the optical element 103 to be positioned so high that the optical element 103 can actually face the optical waveguide end surfaces 109, even when a distance L2 between the surface 2a of the base platform 2 and the peripheral surface portions 101a of the optical waveguides 101 varies per production. In this way, the optical element 103 and the optical waveguides 101 are allowed to be optically coupled with one another.

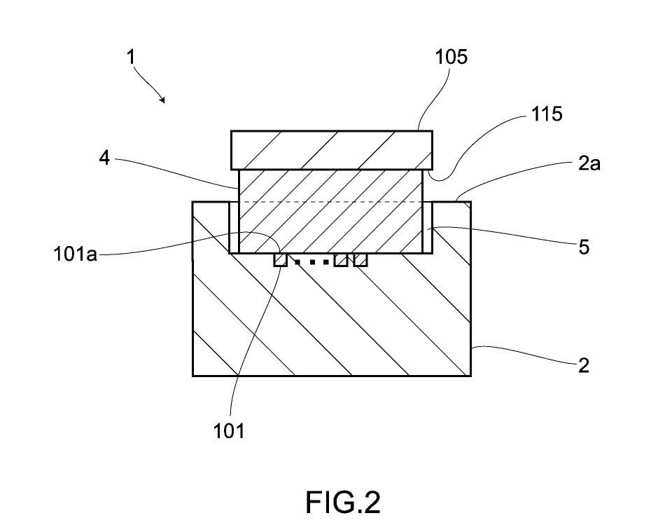

In fact, the optical waveguide exposure section 5 is formed in a given location between a concave section 107 of the base platform 2 and guide pin through holes 110. Specifically, the optical waveguide exposure section 5 is provided as a cutout formed by cutting out a portion between the surface 2a of the base platform 2 and the optical waveguides 101. More specifically, the optical waveguide exposure section 5 is formed into a rectangular parallelepiped shape so that the peripheral surface portions 101a of the optical waveguides 101 can be exposed on the surface 2a of the base platform 2. Further, the optical waveguide exposure section 5 is formed so wide, and so deep as shown in FIG. 2 which is a sectional view taken on line B-B′ of FIG. 1(B), that the spacer 4 supporting the optical module substrate 105 can be mounted therein.

Furthermore, according to the base platform 2 of the present embodiment, the optical waveguide exposure section 5 is actually formed away from a side surface portion 108 of the concave section 107 by a given distance, such side surface portion 108 having the aforementioned optical waveguide end surfaces 109. As a result, an uncut residual portion 6 can thus be formed on a surface between the side surface portion 108 of the concave section 107 and the optical waveguide exposure section 5. In this sense, according to the base platform 2, the peripheral surface portions 101a of the optical waveguides 101 in the vicinity of the side surface portion 108 of the concave section 107 are covered by the residual portion 6 and thus remain unexposed. Accordingly, the optical waveguide end surfaces 109 can be smoothed in a polishing process for forming the optical waveguide end surfaces 109, without causing potential loss in the peripheral surface portions 101a of the optical waveguides 101.

Namely, assuming that there is not provided the residual portion 6 between the side surface portion 108 of the concave section 107 and the optical waveguide exposure section 5, and that the peripheral surface portions 101a of the optical waveguides 101 are exposed in an area ranging from where the spacer 4 is mounted to the optical waveguide end surfaces 109, smoothing the optical waveguide end surfaces 109 may be difficult. The reason for that is because the exposed optical waveguides 101 are directly polished during the polishing process for forming the optical waveguide end surfaces 109, thus causing potential loss in the peripheral surface portions 101a of the optical waveguides 101.

The spacer 4 is also formed into a rectangular parallelepiped shape and has an upper end portion thereof joined to the rear surface 115 of the optical module substrate 105 by means of a joining material 8. The spacer 4 can be mounted in the optical waveguide exposure section 5 when mounting the optical module substrate 105 on the base platform 2. In fact, as shown in FIG. 1(A), an outer peripheral shape of the spacer 4 is substantially identical to the shape of the optical waveguide exposure section 5, and is slightly smaller than an outer peripheral shape of the corresponding optical waveguide exposure section 5.

Further, as shown in FIG. 1(B), a thickness of the spacer 4 in a thickness direction z (referred to as height hereunder) is determined by adjusting a distance L5 between the rear surface 115 of the optical module substrate 105 and the peripheral surface portions 101a of the optical waveguides 101 in a manner such that centers of the optical waveguides 101 are allowed to face a light emitting or a light receiving region of the optical element 103. Namely, the height of the spacer 4 is so determined that a combined distance of the corresponding height and a distance L4 between the peripheral surface portions 101a of the optical waveguides 101 and the centers thereof is equal to a distance L1 between the rear surface 115 of the optical module substrate 105 and the light emitting or the light receiving region of the optical element 103.

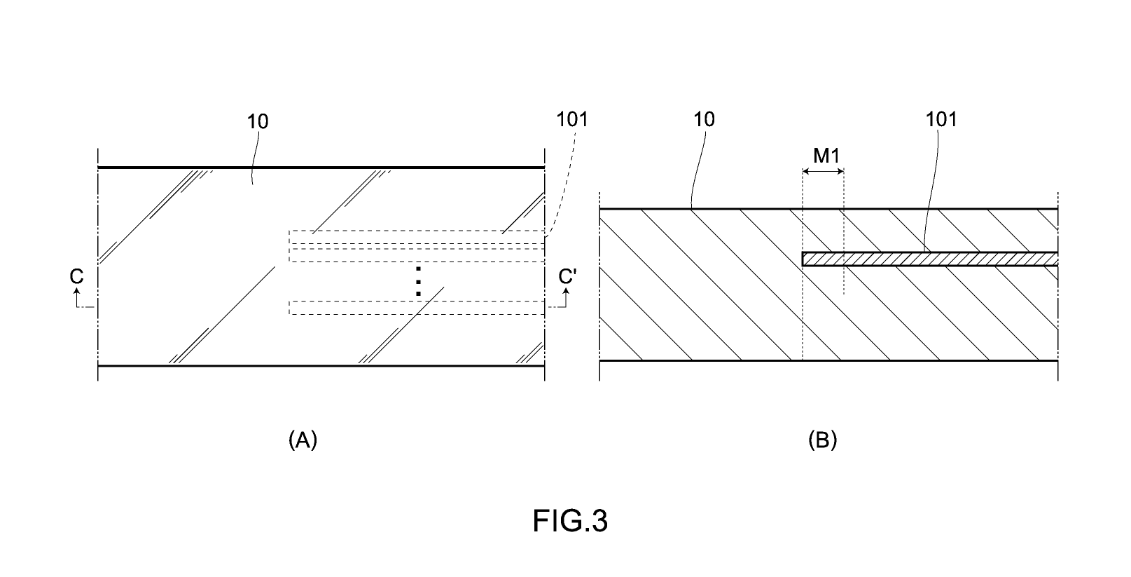

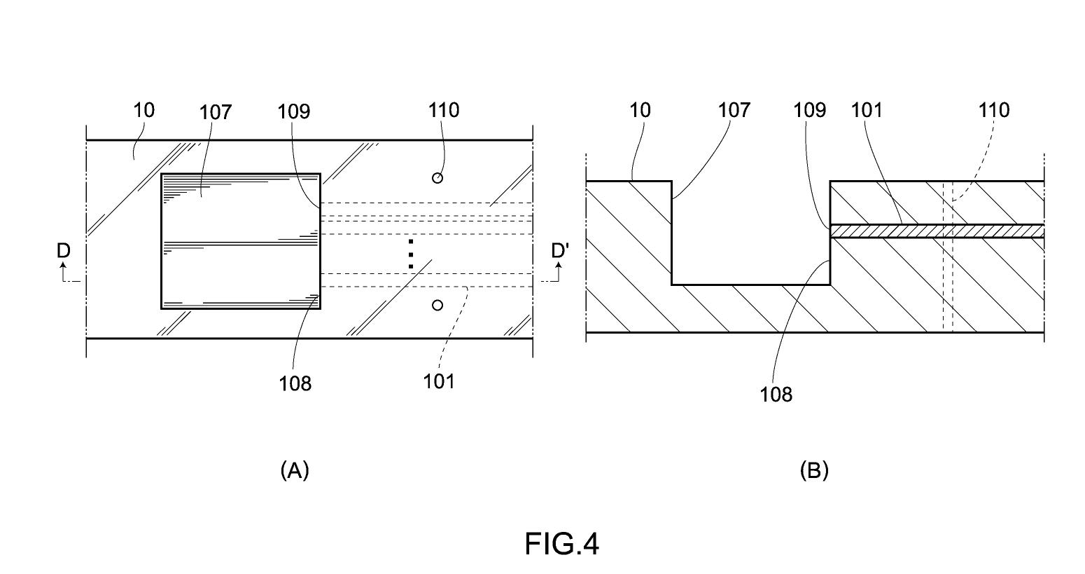

A manufacturing method of the base platform 2 is described hereunder. As shown in FIG. 3(A) and FIG. 3(B) which is a sectional view taken on line C-C′ of FIG. 3(A), there is manufactured a processible base platform 10 having thereinside a plurality of the optical waveguides 101 parallel to one another. Particularly, this processible base platform 10 is manufactured by stacking as well as bonding together a plurality of layers by means of an adhesive agent, according to steps of manufacturing an FR4 printed board. The processible base platform 10 further has a polishable margin M1 extended by the optical waveguides 101 to a concave section formation area. This polishable margin M1 is required for smoothing the optical waveguide end surfaces 109 (FIG. 1(B)) in the polishing process later. Next, as shown in FIG. 4(A) and FIG. 4(B) which is a sectional view taken on line D-D′ of FIG. 4(A), there are bored the guide pin through holes 110 in given locations on the processible base platform 10, followed by routering the concave section formation area provided away from the guide pin through holes 110 by a given distance, thus forming the concave section 107 in terms of removing a portion of a surface of the processible base platform 10.

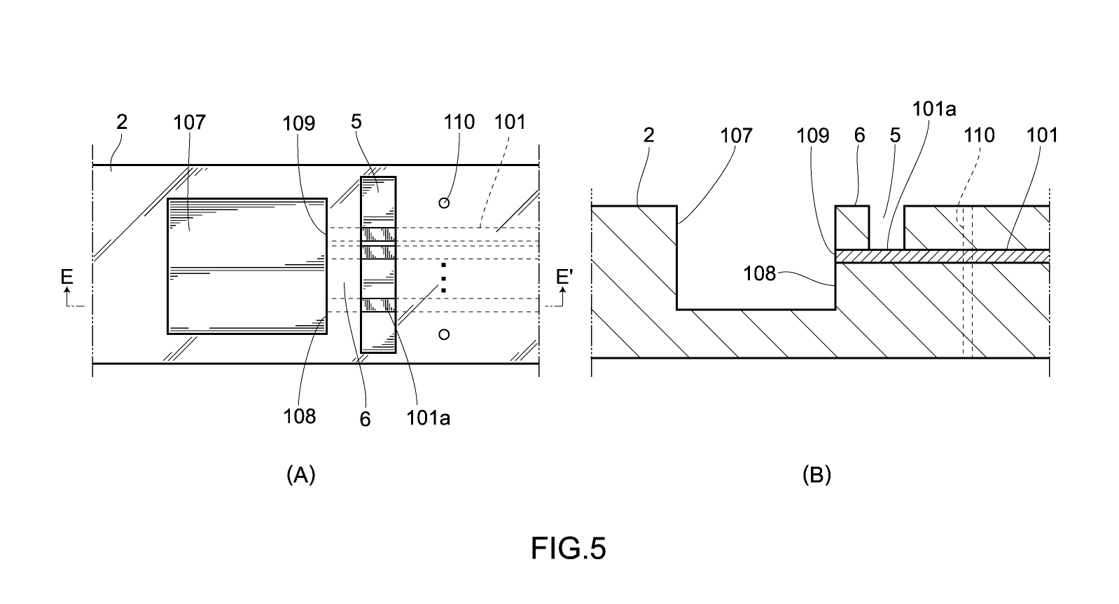

According to the processible base platform 10 thus processed, the side surface portion 108 of the concave section 107 is then polished in the polishing process, thereby smoothing the optical waveguide end surfaces 109. Next, as shown in FIG. 5(A) and FIG. 5(B) which is a sectional view taken on line E-E′ of FIG. 5(A), there are formed the optical waveguide exposure section 5 exposing the peripheral surface portions 101a of the optical waveguides 101, and the residual portion 6. Particularly, the optical waveguide exposure section 5 and the residual portion 6 are formed using a same method for processing a cavity substrate, such optical waveguide exposure section 5 being technically provided away from the concave section 107 by a given distance. The base platform 2 is thus manufactured.

Next, as shown in FIG. 1(B), the spacer 4 provided on the rear surface 115 of the optical module substrate 105 is mounted in the optical waveguide exposure section 5. Further, guide pins 111 are inserted through guide pin through holes 114 of the optical module substrate 105 and the guide pin through holes 110 of the base platform 2. With the guide pins 111 being inserted through the corresponding guide pin through holes, a joining material 117 is used to join together the base platform 2 and the optical module substrate 105, thus completing manufacturing the signal transmission device 1.

According to the signal transmission device 1 having the aforementioned structure, there is selectively removed a portion of the surface 2a located away from the optical waveguide end surfaces 109 of the base platform 2 by a given distance, thus forming the optical waveguide exposure section 5 exposing the peripheral surface portions 101a of the optical waveguides 101 on the surface 2a of the base platform 2. Further, according to this signal transmission device 1, the spacer 4 is interposed between the peripheral surface portions 101a of the optical waveguides 101 exposed by the optical waveguide exposure section 5, and the rear surface 115 of the optical module substrate 105. In this sense, the distance between the rear surface 115 of the optical module substrate 105 and the optical waveguides 101 can simply be adjusted by the height of the spacer 4.

In this sense, according to the signal transmission device 1, the optical element 103 of the optical module substrate 105 can be positioned so high that it can actually face the optical waveguide end surfaces 109, by simply adjusting the height of the spacer 4 from the optical waveguides 101. Namely, the optical element 103 and the optical waveguide end surfaces 109 can reliably face and be optically coupled with one another in the thickness direction z by means of the spacer 4 of a given height, even when the distance L2 between the surface 2a of the base platform 2 and the peripheral surface portions 101a of the optical waveguides 101 varies per production.

Further, according to the signal transmission device 1, the optical waveguide exposure section 5 is formed away from the side surface portion 108 of the concave section 107 by a given distance. Furthermore, there is provided the residual portion 6 between the side surface portion 108 of the concave section 107 and the optical waveguide exposure section 5, so that the peripheral surface portions 101a of the optical waveguides 101 in the corresponding area are unexposed. Accordingly, the optical waveguide end surfaces 109 can be smoothed without causing potential loss in the peripheral surface portions 101a of the optical waveguides 101 during the polishing process.

Furthermore, according to the signal transmission device 1, the residual portion 6 is provided between a supporting portion 113 and the spacer 4. A given space is formed above the corresponding residual portion 6, such space serving to receive excessive portions of the joining material 8 protruding from joint locations at which the supporting portion 113 and the spacer 4 are joined to the optical module substrate 105.

According to the aforementioned structure, the spacer 4 is interposed between the peripheral surface portions 101a of the optical waveguides 101 exposed by the optical waveguide exposure section 5, and the rear surface 115 of the optical module substrate 105. Further, the height of the spacer 4 alone allows the optical element 103 of the optical module substrate 105 to be positioned so high that the optical element 103 can actually face the optical waveguide end surfaces 109. Therefore, it is not required that the spacer be individually manufactured per signal transmission device. Further, there can be avoided individual length measurements of distances including the distance L2 between the surface 2a of the base platform 2 and the peripheral surface portions 101a of the optical waveguides 101. In this way, not only a production efficiency can be improved, but also, a production cost can be reduced in a sense that neither length measurement steps nor length measurement instruments are required.

### (2) Second Embodiment

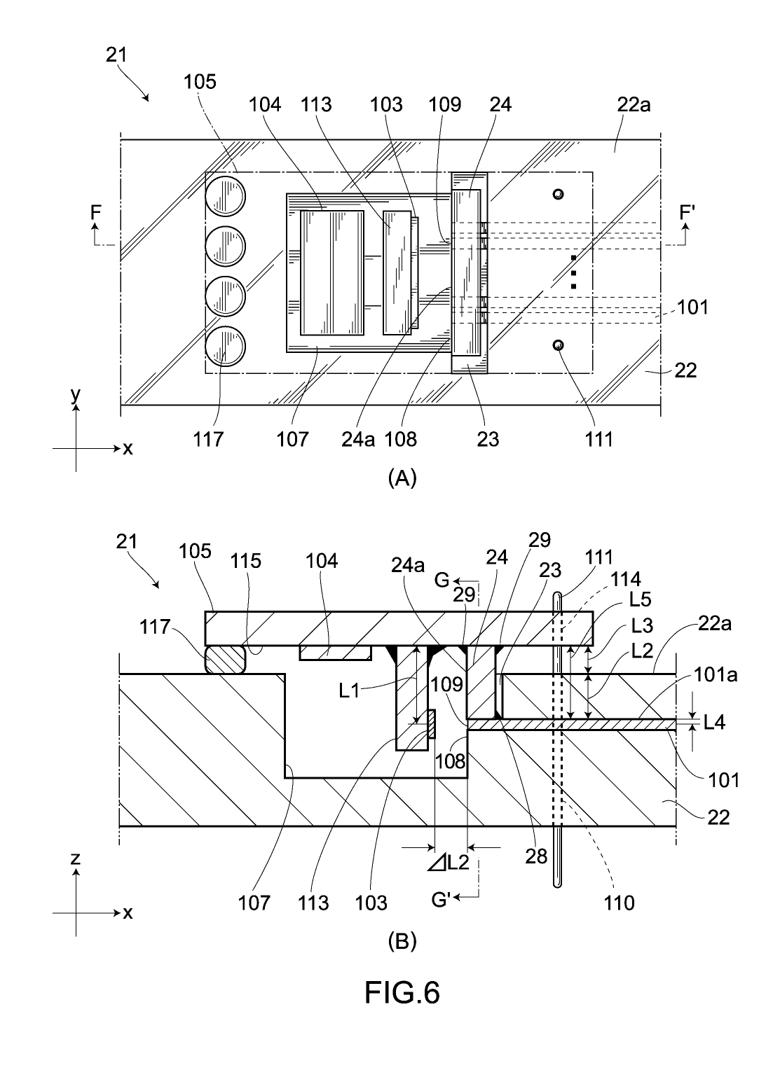

In FIG. 6(A) and FIG. 6(B), a symbol “21” represents a signal transmission device of a second embodiment. Here, elements in FIG. 6(A) and FIG. 6(B) and corresponding elements in FIG. 1(A) and FIG. 1(B), share identical symbols. The signal transmission device of the second embodiment differs from the signal transmission device of the first embodiment in that an optical waveguide exposure section 23 formed on a base platform 22 and a spacer 24 are provided in locations different from those in the first embodiment.

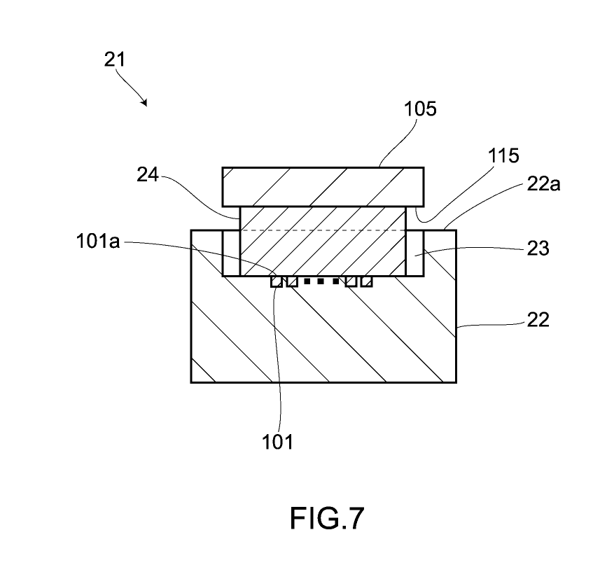

Here, as shown in FIG. 6(A) and FIG. 6(B) which is a sectional view taken on line F-F′ of FIG. 6(A), there is not formed a residual portion corresponding to the residual portion 6 (FIG. 1(B)) on the base platform 22. In fact, there is provided the optical waveguide exposure section 23 adjacent to the concave section 107. Particularly, the optical waveguide exposure section 23 is identical to the optical waveguide exposure section 5 (FIG. 1(B)) of the first embodiment, except that the optical waveguide exposure section 23 is adjacent to the concave section 107. The optical waveguide exposure section 23 is formed so wide, and so deep as shown in FIG. 7 which is a sectional view taken on line G-G′ of FIG. 6(B), that the spacer 24 having a rectangular parallelepiped shape can be mounted therein.

In addition, the spacer 24 is made of a material harder than materials of which the optical waveguides 101 and the base platform 22 are made, such material being ceramic, metal (copper, aluminum) or the like. Further, there is caused no potential loss in a side surface 24a of the spacer 24 during the polishing process for forming the optical waveguide end surfaces 109. Namely, the spacer 24 serves as a stopper since the side surface 24a thereof is not cut during the polishing process for smoothing the optical waveguide end surfaces 109, thus allowing the optical waveguide end surfaces 109 to be formed on a same plane as that of the smooth side surface 24a.

As the polishing process, there is employed a method similar to routering, thus allowing the side surface portion 108 of the concave section 107 to be polished. Here, the spacer 24 is identical to the spacer 4 (FIG. 1(B)) of the first embodiment except for the aforementioned features thereof.

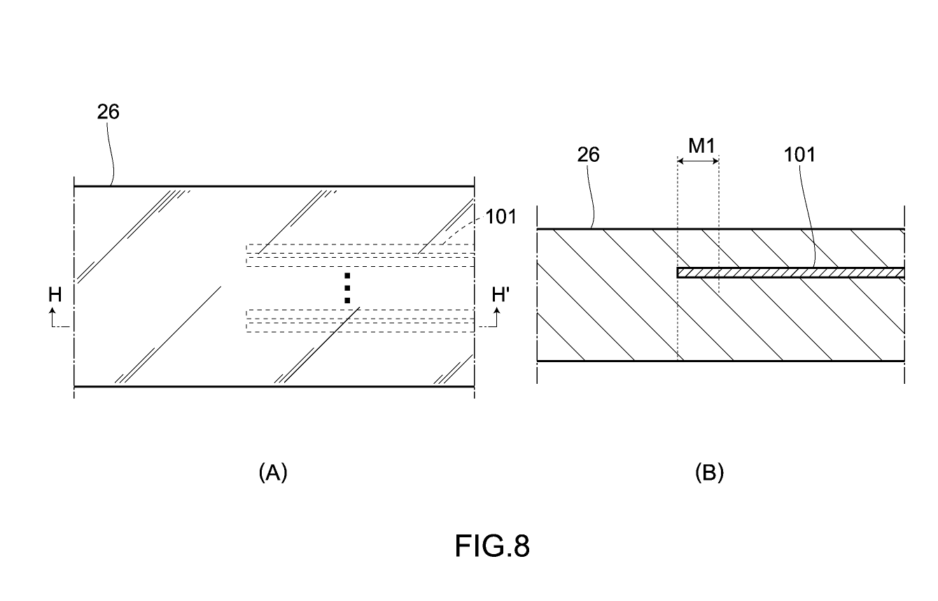

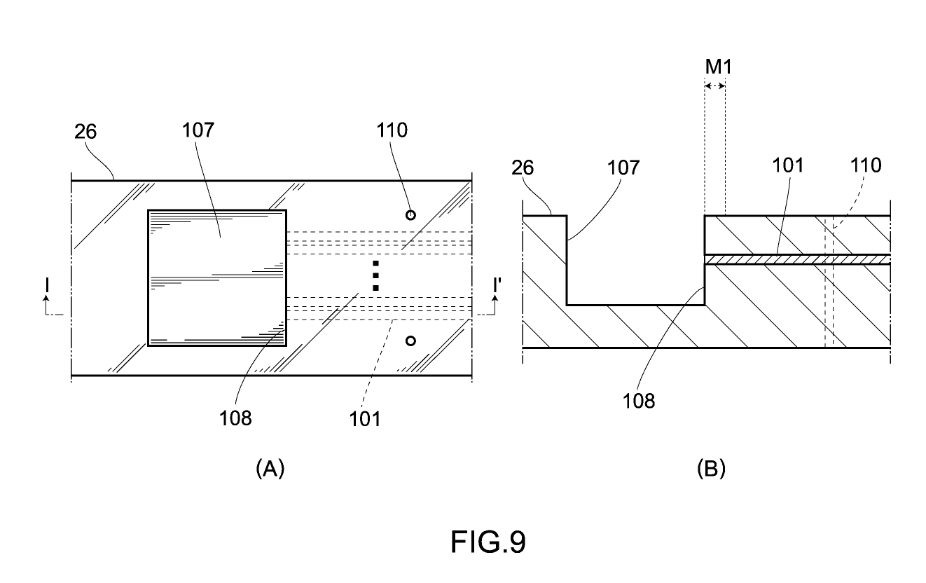

A manufacturing method of the base platform 22 is described hereunder. As shown in FIG. 8(A) and FIG. 8(B) which is a sectional view taken on line H-H′ of FIG. 8(A), there is manufactured a processible base platform 26 having thereinside a plurality of the optical waveguides 101 parallel to one another. Particularly, this processible base platform 26 is manufactured by stacking as well as bonding together a plurality of layers by means of an adhesive agent, according to steps of manufacturing a FR4 printed board. The processible base platform 26 further has a polishable margin M1 extended by the optical waveguides 101 to the concave section formation area. This polishable margin M1 is required for smoothing the optical waveguide end surfaces 109 in the polishing process later. Next, as shown in FIG. 9(A) and FIG. 9(B) which is a sectional view taken on line I-I′ of FIG. 9(A), there are bored the guide pin through holes 110 in given locations on the processible base platform 26, followed by routering the concave section formation area provided away from the guide pin through holes 110 by a given distance, thus forming the concave section 107 of a rectangular parallelepiped shape in terms of removing a portion of a surface of the processible base platform 26. Particularly, the polishable margin M1 of a given width is now provided on the side surface portion 108 of the concave section 107.

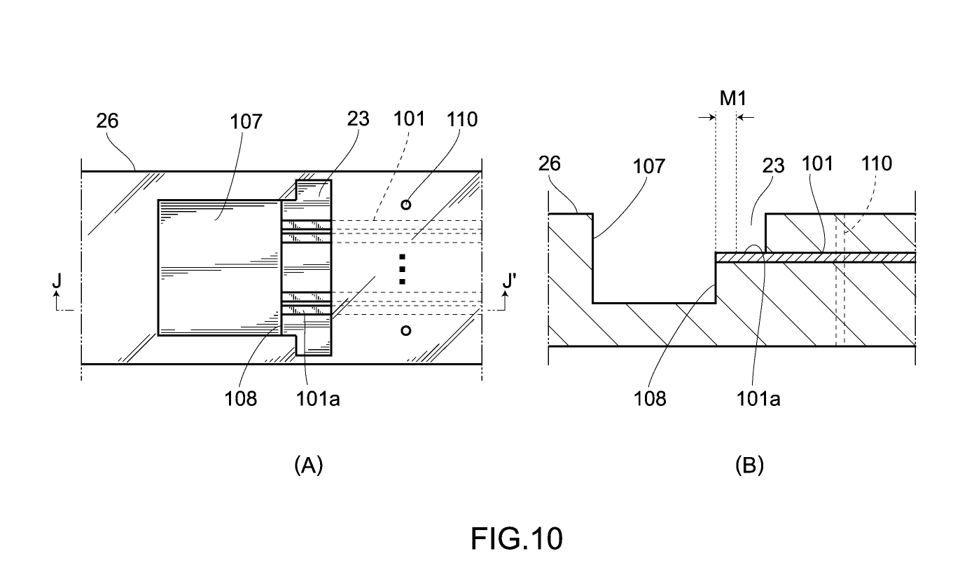

In addition, as shown in FIG. 10(A) and FIG. 10(B) which is a sectional view taken on line J-J′ of FIG. 10(A), there is formed the optical waveguide exposure section 23 exposing the peripheral surface portions 101a of the optical waveguides 101. Particularly, the optical waveguide exposure section 23 is formed by processing an area adjacent to the concave section 107 and above the peripheral surface portions 101a of the optical waveguides 101, in a similar way as to manufacture a cavity substrate. Further, this optical waveguide exposure section 23 is formed into a rectangular parallelepiped shape and communicated with the concave section 107. Furthermore, the polishable margin M1 of a given width is now located on the bottom of the optical waveguide exposure section 23.

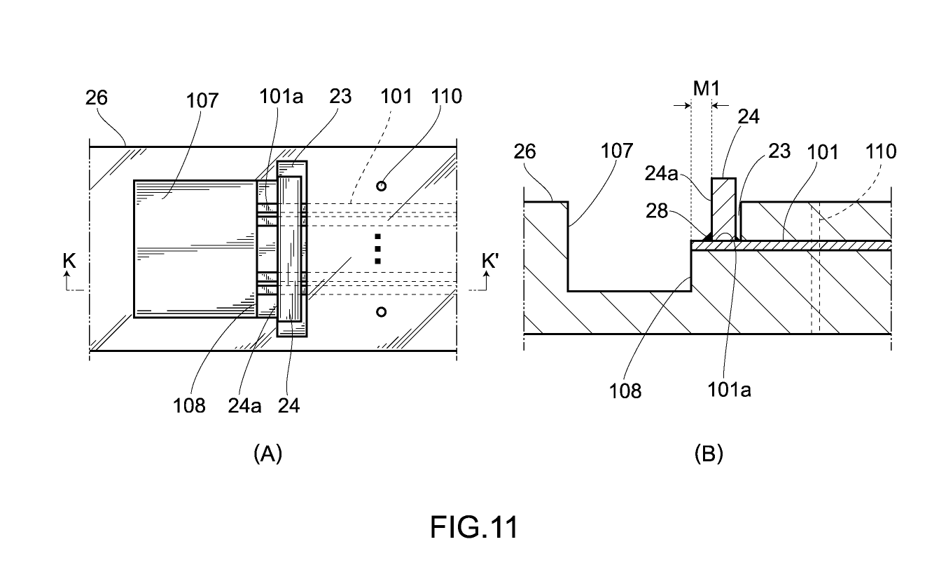

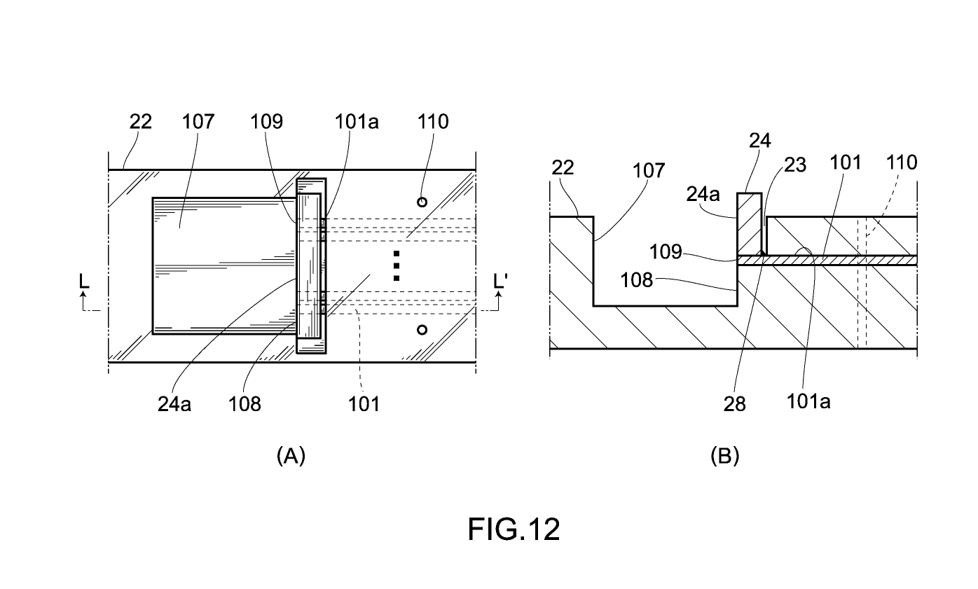

Next, as shown in FIG. 11(A) and FIG. 11(B) which is a sectional view taken on line K-K′ of FIG. 11(A), the spacer 24 is then mounted on the peripheral surface portions 101a of the optical waveguides 101 exposed by the optical waveguide exposure section 23, in the presence of the polishable margin M1. With the spacer 24 being positioned in this way, a joining material 28 is then used to fix the spacer 24 in the optical waveguide exposure section 23. Next, the polishable margin M1 located in an area adjacent to the side surface 24a of the spacer 24 is polished so as to form the optical waveguide end surfaces 109 on the side surface portion 108 of the concave section 107, thus completing manufacturing the base platform 22. Here, according to the second embodiment, the spacer 24 is made of a material harder than materials of which the optical waveguides 101 and the base platform 22 are made. Specifically, the spacer 24 is hardly polished during the polishing process. More specifically, the side surface 24a thereof is not cut during the polishing process, thereby allowing the spacer 24 to serve as a stopper at that time, thus allowing the optical waveguide end surfaces 109 to be formed on the same plane as that of the side surface 24a of the spacer 24 as shown in FIG. 12(A) and FIG. 12(B) which is a sectional view taken on line L-L′ of FIG. 12(A).

Next, as shown in FIG. 6(B), the guide pins 111 are inserted through the guide pin through holes 114 of the optical module substrate 105 and the guide pin through holes 110 of the base platform 2, thereby joining an upper portion of the spacer 24 or the like to the optical module substrate 105 by means of joining materials 29, 117, thus completing manufacturing the signal transmission device 21.

According to the signal transmission device 21 having the aforementioned structure, the spacer 24 is interposed between the peripheral surface portions 101a of the optical waveguides 101 exposed by the optical waveguide exposure section 23, and the rear surface 115 of the optical module substrate 105. Particularly, a distance between the rear surface 115 of the optical module substrate 105 and the optical waveguides 101 is adjusted simply by a height of the spacer 24.

In this sense, according to the signal transmission device 21, the optical element 103 of the optical module substrate 105 can be positioned so high that it can actually face the optical waveguide end surfaces 109, by simply adjusting the height of the spacer 24 from the optical waveguides 101. Namely, the optical element 103 and the optical waveguide end surfaces 109 can reliably face and be optically coupled with one another in the thickness direction z by means of the spacer 24 of a given height, even when the distance L2 between the surface 22a of the base platform 22 and the peripheral surface portions 101a of the optical waveguides 101 varies per production.

In addition, according to the signal transmission device 21, the spacer 24 is made of a material harder than the materials of which the optical waveguides 101 and the base platform 22 are made. Accordingly, the side surface 24a of the spacer 24 is not cut during the polishing process for forming the optical waveguide end surfaces 109, thereby allowing the spacer 24 to serve as a stopper for restricting a polishable area, and thus allowing the optical waveguide end surfaces 109 to be formed on the same plane as that of the side surface 24a of the spacer 24. In this way, the signal transmission device 21 allows the optical waveguide end surfaces 109 to be precisely formed with respect to the side surface 24a of the spacer 24 through the polishing process, thus preventing a gap ΔL2 between the optical element 103 and the optical waveguide end surfaces 109 from varying per production.

In this regard, according to a conventional signal transmission device 100 shown in FIG. 26(B), the optical waveguide end surfaces 109 of a base platform 102 are also formed through a polishing process, and the locations of the corresponding optical waveguide end surfaces 109 may erroneously vary to a certain degree with respect to the locations of the guide pin through holes 110. Accordingly, a gap ΔL1 between the optical element 103 and the optical waveguide end surfaces 109 may vary per production, thus causing an optical coupling efficiency to also vary per production and reducing a yield ratio.

Further, a low optical coupling efficiency is achieved in the signal transmission device 100 with an enlarged gap ΔL1 between the optical element 103 and the optical waveguide end surfaces 109. Particularly, the enlarged gap ΔL1 causes optical losses to occur at each optical coupling point along an optical transmission path ranging from an optical transmitting element (optical element) to an optical receiving element (optical element) through the optical waveguides 101, thereby reducing a light receiving level of the optical receiving element, and thus resulting in a low optical coupling efficiency between the optical element 103 and the optical waveguides 101. Accordingly, an optical output level of the optical transmitting element has to be increased in order to compensate the aforementioned losses, thus resulting in an increase in power consumption corresponding to a drive current increased.

In contrast, according to the signal transmission device 21 of the second embodiment, the spacer 24 is precisely mounted in a given location, and the polishing process is then performed with the spacer 24 being mounted therein so as to form the optical waveguide end surfaces 109 with respect to the side surface 24a of the spacer 24. In this way, the distance between the locations of the guide pin through holes 110 and the locations of the optical waveguide end surfaces 109 can be prevented from varying in the polishing process per production. Specifically, the signal transmission device 21 allows the gap ΔL2 between the optical element 103 and the optical waveguide end surfaces 109 to remain constant, thereby improving the optical coupling efficiency between the optical element 103 and the optical waveguide end surfaces 109 and raising the yield ratio. Further, since the gap ΔL2 between the optical element 103 and the optical waveguide end surfaces 109 can also be constant, optical losses resulting from the variance in the gap ΔL2 are unlikely to occur in terms of the optical coupling between the optical element 103 and the optical waveguides 101, thereby reducing power consumption dedicated to the optical losses in the optical element serving as an optical transmitting element.

### (3) Third Embodiment

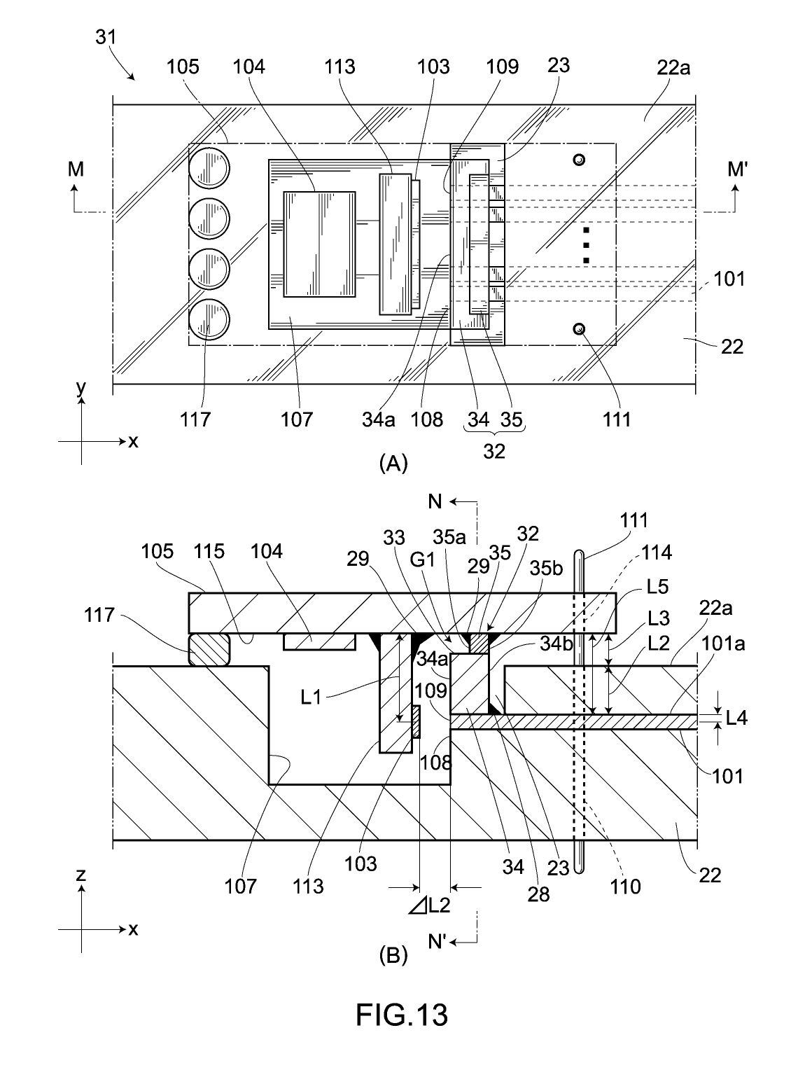

In FIG. 13(A) and FIG. 13(B), a symbol “31” represents a signal transmission device of a third embodiment. Here, elements in FIG. 13(A) and FIG. 13(B) and corresponding elements in FIG. 6(A) and FIG. 6(B), share identical symbols. The signal transmission device of the third embodiment differs from the signal transmission device of the second embodiment in that a step portion 33 is formed on a side surface of a spacer 32. As shown in FIG. 13(A) and FIG. 13(B) which is a sectional view taken on line M-M′ of FIG. 13(A), there is formed a receiving space G1 by the step portion 33 provided as a concave portion on the side surface of the spacer 32. The receiving space G1 serves to receive excessive portions of the joining material 29 protruding from joint locations at which the supporting portion 113 and the spacer 32 are joined to the optical module substrate 105.

In fact, the spacer 32 is composed of a first spacer portion 34 fixed to the peripheral surface portions 101a of the optical waveguides 101 exposed by the optical waveguide exposure section 23, and a second spacer portion 35 separately provided from the first spacer portion 34 but interposed between the corresponding first spacer portion 34 and the rear surface 115 of the optical module substrate 105. The spacer 32 of the present embodiment is composed of the first spacer portion 34 and the second spacer portion 35 separately provided from the first spacer portion 34. However, the preset invention is not limited to this configuration. As a matter of fact, there can also be employed a single-piece spacer integrally including the first spacer portion and the second spacer portion.

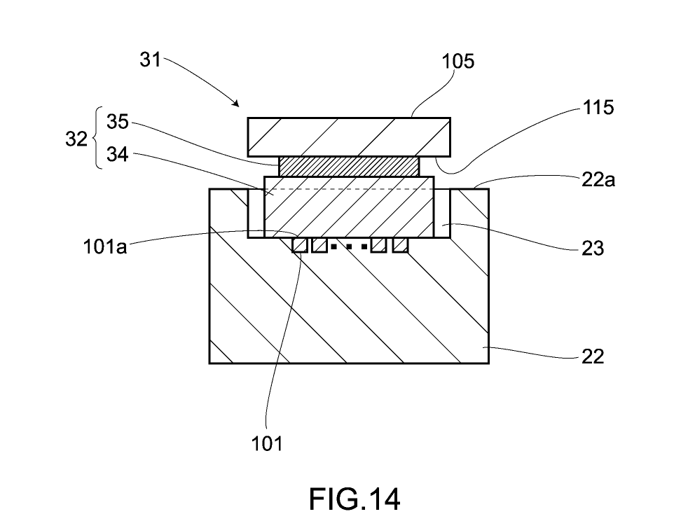

As shown in FIG. 14 which is a sectional view taken on line N-N′ of FIG. 13(B), the spacer 32 is interposed between the peripheral surface portions 101a of the optical waveguides 101 exposed by the optical waveguide exposure section 23, and the rear surface 115 of the optical module substrate 105. Further, a combined height of the first spacer portion 34 and the second spacer portion 35 is so determined that the centers of the optical waveguides 101 are allowed to face the light receiving or the light emitting region of the optical element 103. Accordingly, the spacer 32 allows the same effects as those in the second embodiment to be achieved.

Further, the first spacer portion 34 is formed into a rectangular parallelepiped shape, and is made of a material harder than the materials of which the optical waveguides 101 and the base platform 22 are made. Accordingly, there is caused no potential loss in the first spacer portion 34 during the polishing process for forming the optical waveguide end surfaces 109. Namely, a side surface 34a of the first spacer portion 34 is not cut during the polishing process for smoothing the optical waveguide end surfaces 109, thereby allowing the first spacer portion 34 to serve as a stopper and the optical waveguide end surfaces 109 to be formed on a same plane as that of the side surface 34a.

The second spacer portion 35 can be variously made of a hard material of which the first spacer portion 34 is made, or a material of which the base platform 22 is made, or even a material other than those materials. According to the present embodiment, the second spacer portion 35 is also formed into a rectangular parallelepiped shape with an x-direction dimension (width) thereof being shorter than a width of the first spacer portion 34. Further, when mounted on an upper portion of the first spacer portion 34, the second spacer portion 35 allows a side surface 35a thereof to face the supporting portion 113. Furthermore, as shown in FIG. 13(B), an other side surface 35b facing away from the side surface 35a is aligned on a same plane as that of an other side surface 34b of the first spacer portion 34. In this way, the step portion 33 provided as a concave section is formed on a boundary between the side surface 34a of the first spacer portion 34 and the side surface 35a of the second spacer portion 35, such step portion 33 further allowing the receiving space G1 to be formed between the second spacer portion 35 and the supporting portion 113.

In this sense, according to the spacer 32, the receiving space G1 formed in the vicinity of the optical module substrate 105 is technically formed between the supporting portion 113 and the second spacer portion 35 facing the supporting portion 113. Therefore, the receiving space G1 is allowed to receive excessive portions of the joining material 29 partially protruding from where the supporting portion 113 and the second spacer portion 35 are fixed to the rear surface 115 of the optical module substrate 105.

According to the present invention, the other side surface 34b of the first spacer portion 34 and the other side surface 35b of the second spacer portion 35 are aligned on the same plane, thus forming the step portion 33 on the boundary between the side surface 34a of the first spacer portion 34 and the side surface 35a of the second spacer portion 35. However, the present invention is not limited to this configuration. As a matter of fact, there may also be provided a step portion between the other side surface 34b of the first spacer portion 34 and the other side surface 35b of the second spacer portion 35, as long as the step portion 33 provided as a concave section is formed on the boundary between the side surface 34a of the first spacer portion 34 and the side surface 35a of the second spacer portion 35.

Here, a manufacturing method of the base platform 22 of the third embodiment is identical to the manufacturing method of the base platform 22 of the second embodiment. Specifically, there can be manufactured the base platform 22 with the optical waveguide end surfaces 109 being aligned on the same plane as that of the side surface 34a of the first spacer portion 34, by simply replacing the spacer 24 shown in FIG. 11 and FIG. 12 with the first spacer portion 34. Further, according to the third embodiment, when joining the optical module substrate 105 to the base platform 22, the second spacer portion 35 is particularly so joined to the rear surface 115 of the optical module substrate 105 with the joining material 29, that there can be actually formed the step portion 33 provided as a concave section on the boundary between the side surface 34a of the first spacer portion 34 and the side surface 35a of the second spacer portion 35. Furthermore, as shown in FIG. 13(B), the guide pins 111 are inserted through the guide pin through holes 114 of the optical module substrate 105 and the guide pin through holes 110 of the base platform 22, thereby allowing the optical module substrate 105 to be joined to the base platform 22 by means of the joining material 117, thus completing manufacturing the signal transmission device 31.

There can be achieved the same effects as those of the signal transmission device of the second embodiment, with the signal transmission device 31 having the aforementioned structure. Further, there is formed the receiving space G1 in the region above the first spacer portion 34 and where the supporting portion 113 and the second spacer portion 35 face each other. This receiving space G1 can receive excessive portions of the joining material 29 protruding from joint locations at which the supporting portion 113 and the second spacer portion 35 are joined to the optical module substrate 105, even when the supporting portion 113 and the spacer 32 are close to one another.

Particularly, the first spacer portion 34 has a given and fixed width allowing the spacer 32 to be stably mounted on the bottom of the optical waveguide exposure section 23, even in the presence of the receiving space G1.

### (4) Spacer Mounting Jig

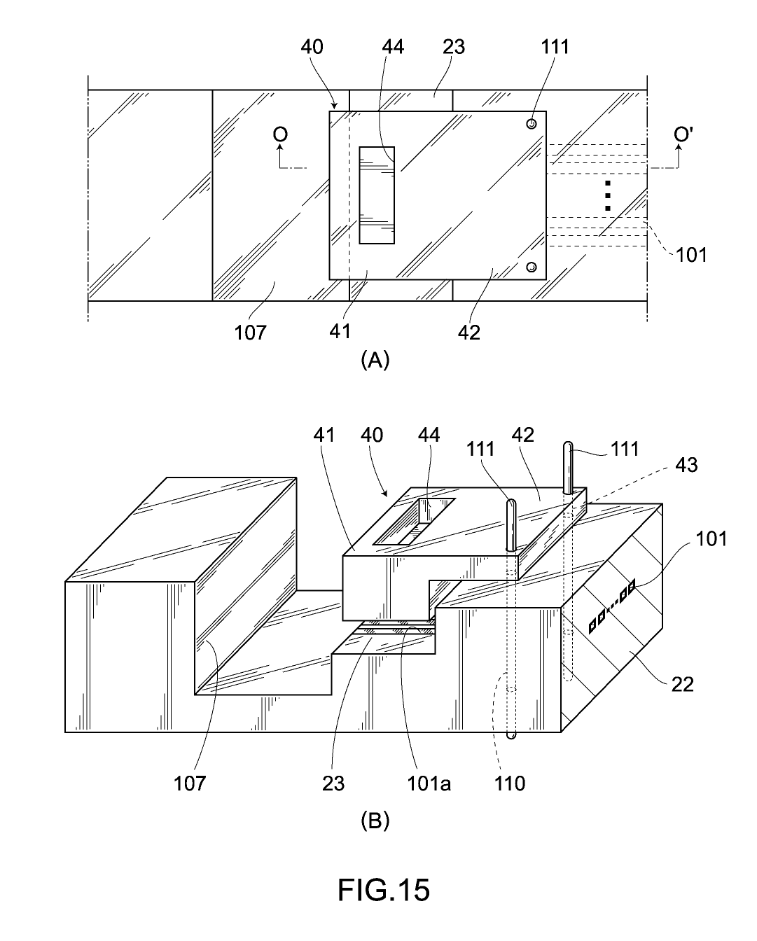

As described above, the optical waveguide end surfaces 109 have to be formed on the same planes as those of the side surface 24a and the side surface 34a. Therefore, the spacer 24 of the second embodiment and the first spacer portion 34 of the third embodiment need to be precisely mounted, during the manufacturing process, with respect to the locations where the optical waveguide end surfaces 109 are to be formed. Here, a spacer mounting jig 40 shown in FIG. 15(A) and FIG. 15(B) is used to precisely mount the spacer 24 as well as the first spacer portion 34 in the optical waveguide exposure section 23.

The spacer mounting jig 40 is made of a board member having a given thickness. Particularly, this spacer mounting jig 40 integrally comprises a thick-walled mounting portion 41, and a positioning portion 42 which is thin-walled as compared to the mounting portion 41. Pin insertion holes 43 are further bored on the corresponding positioning portion 42. Particularly, the pin insertion holes 43 are bored in locations corresponding to the guide pin through holes 110 of the base platform 22 positioned underneath the spacer mounting jig 40, such pin insertion holes 43 allowing the guide pins 111 to be inserted therethrough. Accordingly, the spacer mounting jig 40 can be precisely positioned to the base platform 22 by allowing the guide pins 111 inserted through the guide pin through holes 110 of the base platform 22 to be further inserted through the pin insertion holes 43 of the positioning portion 42.

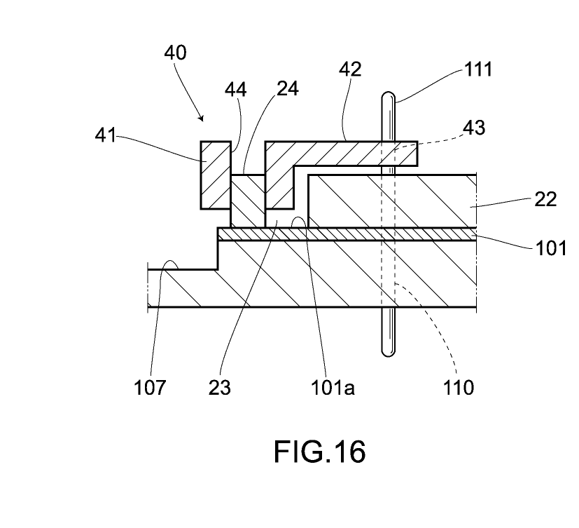

Further, a through hole 44 is bored on the mounting portion 41 integrally coupled with the positioning portion 42. Particularly, this through hole 44 is, for example, formed into a shape substantially identical to an outer peripheral shape of the spacer 24, but is slightly larger than the corresponding spacer 24. The through hole 44 is allowed to face a given location in the optical waveguide exposure section 23 in which the spacer 24 is to be mounted, when the positioning portion 42 has been positioned to the base platform 22 through the guide pins 111. In this way, as shown in FIG. 16 which is a sectional view taken on line O-O′ of FIG. 15(A), the spacer 24 can be inserted through the through hole 44 of the mounting portion 41 from above, followed by allowing the spacer 24 thus inserted to land in the optical waveguide exposure section 23 along the corresponding through hole 44, thus precisely mounting the spacer 24 in a given location in the optical waveguide exposure section 23. A joining material is then used to join the spacer 24 thus positioned to the optical waveguide exposure section 23.

Namely, the spacer mounting jig 40 allows the mounting portion 41 thereof to be precisely positioned to the base platform 22 by simply allowing the guide pins 111 of the base platform 22 to be inserted through the pin insertion holes 43. Subsequently, the spacer 24 is simply inserted through and dropped along the through hole 44 of the mounting portion 41 thus positioned, thus allowing the corresponding spacer 24 to be precisely mounted in the optical waveguide exposure section 23. In this sense, a manufacturing method employing the aforementioned spacer mounting jig 40 is preferred in terms of automatizing the manufacturing process and mass production eventually.

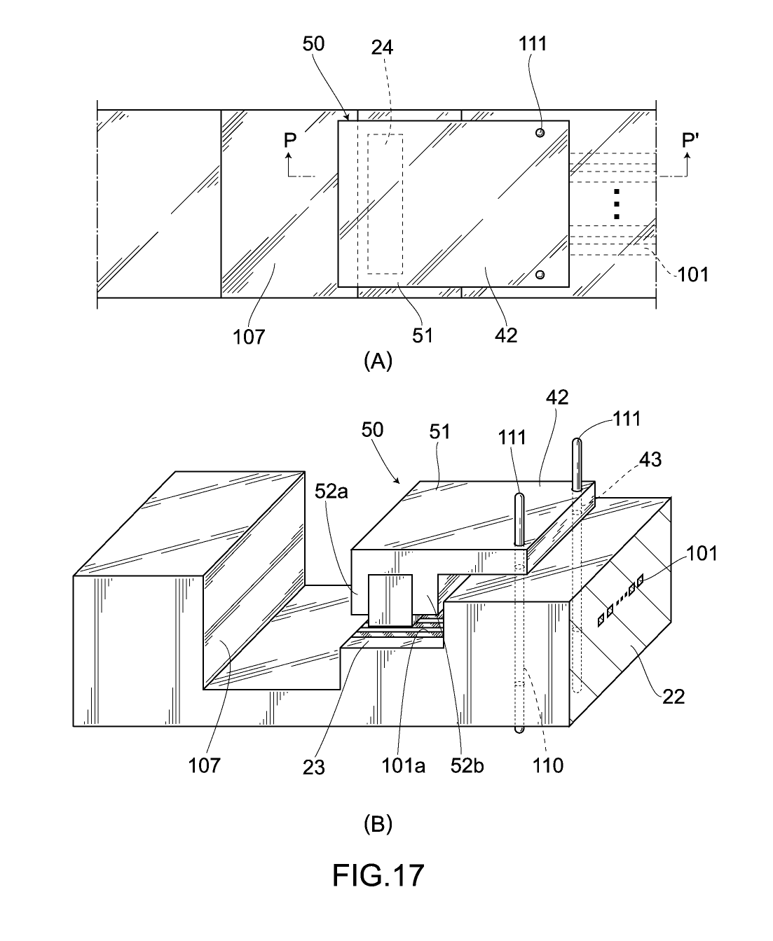

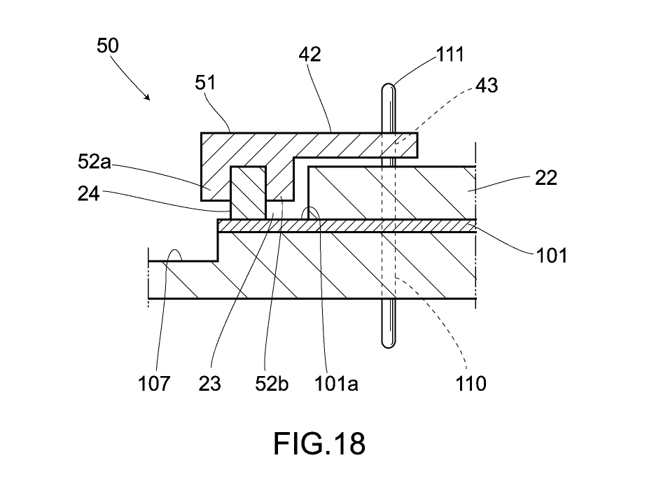

In FIG. 17(A) and FIG. 17(B), a symbol “50” represents a spacer mounting jig of an other embodiment. The spacer mounting jig 50 differs from the spacer mounting jig 40 in terms of a configuration of an mounting portion 51. A cross section of the mounting portion 51 of the spacer mounting jig 50 is formed into a U-shape. Further, the spacer 24 is allowed to be held between protruding portions 52a, 52b protruding from an undersurface of the mounting portion 51. As shown in FIG. 18 which is a sectional view taken on line P-P′ of FIG. 17(A), with the spacer 24 being held between the protruding portions 52a, 52b, the spacer mounting jig 50 is positioned by allowing the guide pins 111 to be inserted through the pin insertion holes 43 of a positioning portion, followed by moving the spacer mounting jig 50 thus positioned toward the base platform 22 along the guide pins 111 until the spacer 24 held between the protruding portions 52a, 52b has landed on a given location in the optical waveguide exposure section 23.

Next, the spacer 24 held by the mounting portion 51 is joined to the optical waveguide section 23 by means of, for example, a joining material, followed by lifting the entire spacer mounting jig 50 along the guide pins 111 so as to release the spacer 24 from the protruding portions 52a, 52b. Namely, the spacer mounting jig 50 allows the spacer 24 to be precisely positioned to the base platform 22 by simply allowing the guide pins 111 of the base platform 22 to be inserted through the pin insertion holes 43 of the spacer mounting jig 50.

### (5) Fourth Embodiment

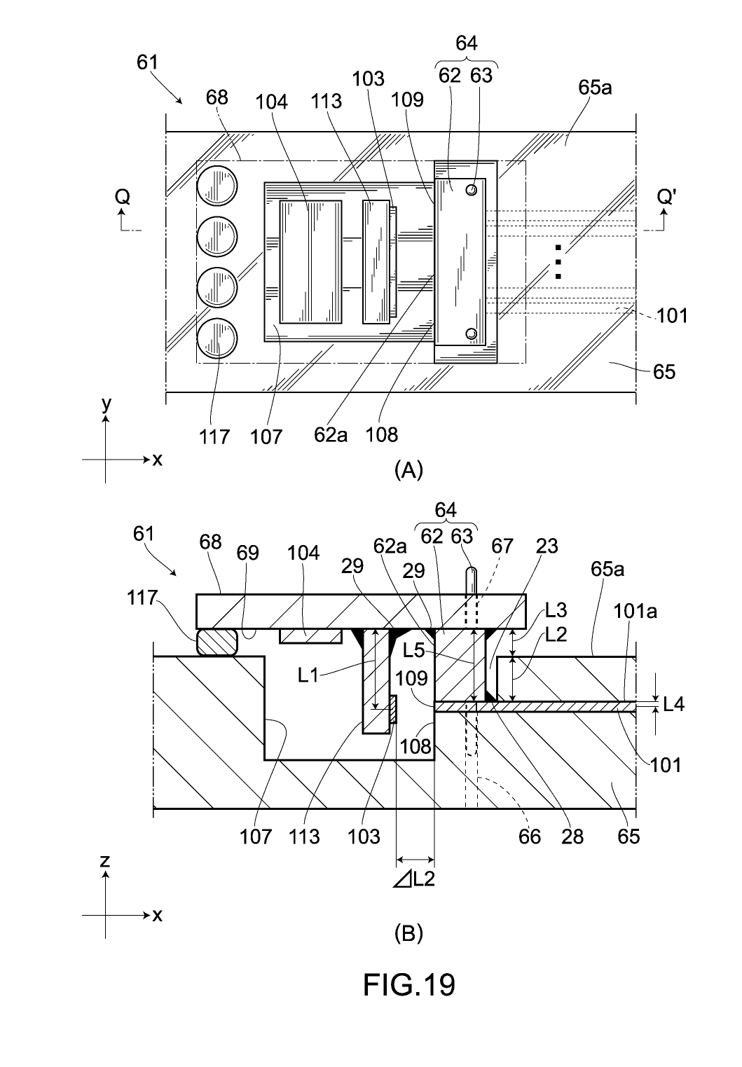

In FIG. 19(A) and FIG. 19(B), a symbol “61” represents a signal transmission device of a fourth embodiment. Here, elements in FIG. 19(A) and FIG. 19(B) and corresponding elements in FIG. 6(A) and FIG. 6(B), share identical symbols. The signal transmission device 61 differs from the signal transmission device of the second embodiment in that there is employed a pin-equipped spacer 64 composed of a spacer main body 62 equipped with guide pins 63. As shown in FIG. 19(A) and FIG. 19(B) which is a sectional view taken on line Q-Q′ of FIG. 19(A), there are provided on a base platform 65 guide pin through holes 66 longitudinally passing through two side portions of the bottom portion of the optical waveguide exposure section 23 in a manner such that one or more optical waveguides 101 are not affected. The guide pins 63 protruding from a lower end portion of the pin-equipped spacer 64 are allowed to be inserted into the guide pin through holes 66. Further, there are bored on an optical module substrate 68 guide pin through holes 67 corresponding to the guide pin through holes 66 of the base platform 65 positioned underneath the optical module substrate 68. The guide pins 63 protruding from an upper end portion of the pin-equipped spacer 64 are thus allowed to be inserted through the guide pin through holes 67.

The optical waveguide end surfaces 109 of the base platform 65 are formed on a same plane as that of a side surface 62a of the spacer main body 62 of the pin-equipped spacer 64. Further, the optical waveguide end surfaces 109 and the optical element 103 of the optical module substrate 68 face one another with a given gap ΔL2 provided therebetween, thus allowing the optical waveguides 101 and the optical element 103 to be optically coupled with one another.

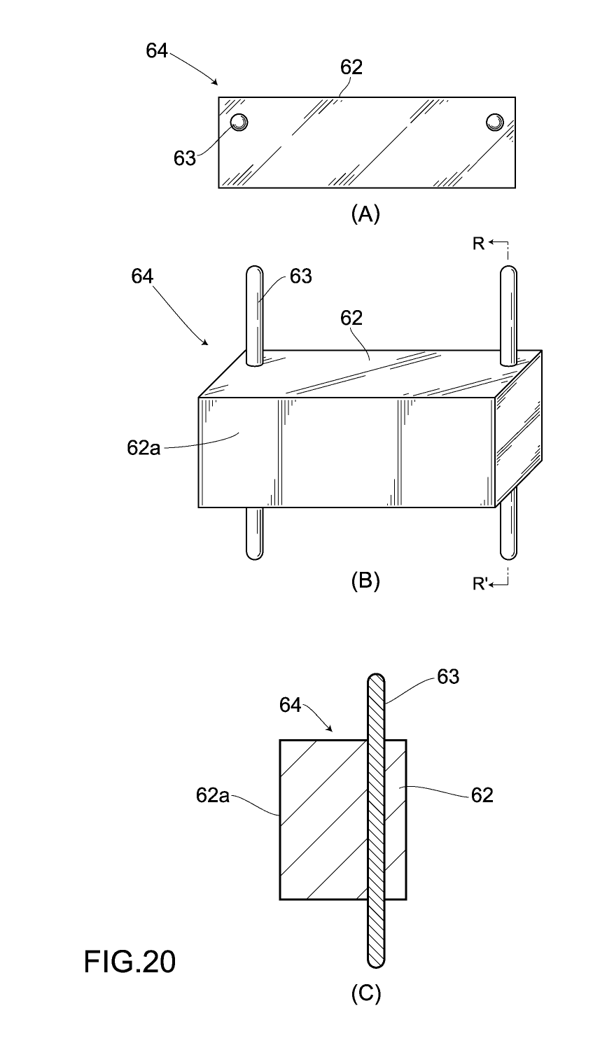

In fact, as shown in FIG. 20(A), FIG. 20(B) and FIG. 20(C), the pin-equipped spacer 64 has two guide pins 63 disposed through the spacer main body 62 formed into a rectangular parallelepiped shape, such guide pins 63 being particularly provided separately from one another at a given distance. Further, frond ends of the guide pins 63 are allowed to protrude from both an upper end portion and a lower end portion of the spacer main body 62. Here, as shown in FIG. 20(C) which is a sectional view taken on line R-R′ of FIG. 20(B), the spacer main body 62 and the guide pins 63 of the present embodiment are separately provided from one another. However, the present invention is not limited to such configuration. As a matter of fact, the spacer main body 62 and the guide pins 63 may be integrally formed together.

The spacer main body 62 is made of a material harder than materials of which the optical waveguides 101 and the base platform 65 are made, such material being ceramic, metal (copper, aluminum) or the like. Therefore, there is caused no potential loss in the side surface 62a during the polishing process for forming the optical waveguide end surfaces 109. Namely, the side surface 62a of the spacer main body 62 is not cut during the polishing process for smoothing the optical waveguide end surfaces 109, thereby allowing the spacer main body 62 to serve as a stopper and the optical waveguide end surfaces 109 to be formed on the same plane as that of the side surface 62a. Further, the height of the spacer main body 62 (i.e., a distance L5) is so determined that a combined distance of the corresponding height and a distance L4 between the peripheral surface portions 101a of the optical waveguides 101 and the centers thereof is equal to a distance L1 between a rear surface 69 of the optical module substrate 68 and the light emitting or the light receiving region of the optical element.

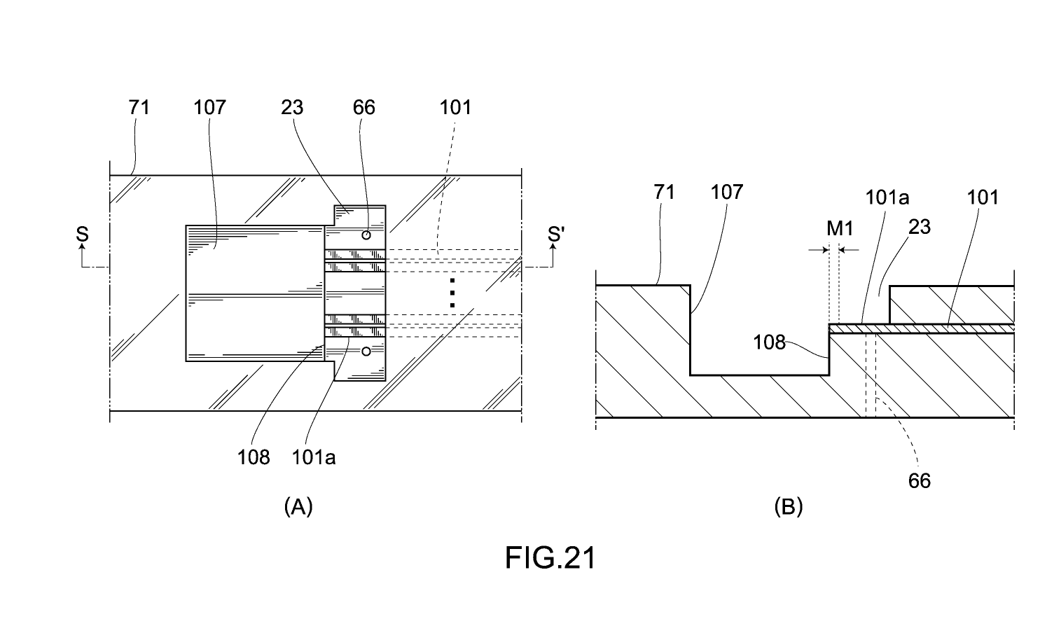

A manufacturing method of the base platform 65 is described hereunder. As shown in FIG. 21(A) and FIG. 21(B) which is a sectional view taken on line S-S′ of FIG. 21(A), a concave section formation area of a processible base platform 71 is routered, thus forming the concave section 107 of a rectangular parallelepiped shape, in terms of removing a portion of a surface of the processible base platform 71. A polishable margin M1 of a given width is provided on the side surface portion 108 of the concave section 107 thus formed.

Next, an area of the processible base platform 71 adjacent to the concave section 107 and above the peripheral surface portions 101a of the optical waveguides 101, are routered, thereby forming the optical waveguide exposure section 23 exposing the peripheral surface portions 101a of the optical waveguides 101 on the surface of the processible base platform 71. This optical waveguide exposure section 23 is formed into a rectangular parallelepiped shape and communicated with the concave section 107. Furthermore, the polishable margin M1 of a given width is now located on the bottom of the optical waveguide exposure section 23. In addition, according to the present embodiment, the guide pin through holes 66 are bored on the bottom of the optical waveguide exposure section 23. Specifically, such guide pin through holes 66 longitudinally pass through the bottom portion of the optical waveguide exposure section 23, and are particularly bored in given locations on both sides of the optical waveguides 101 so that the optical waveguides 101 are not affected.

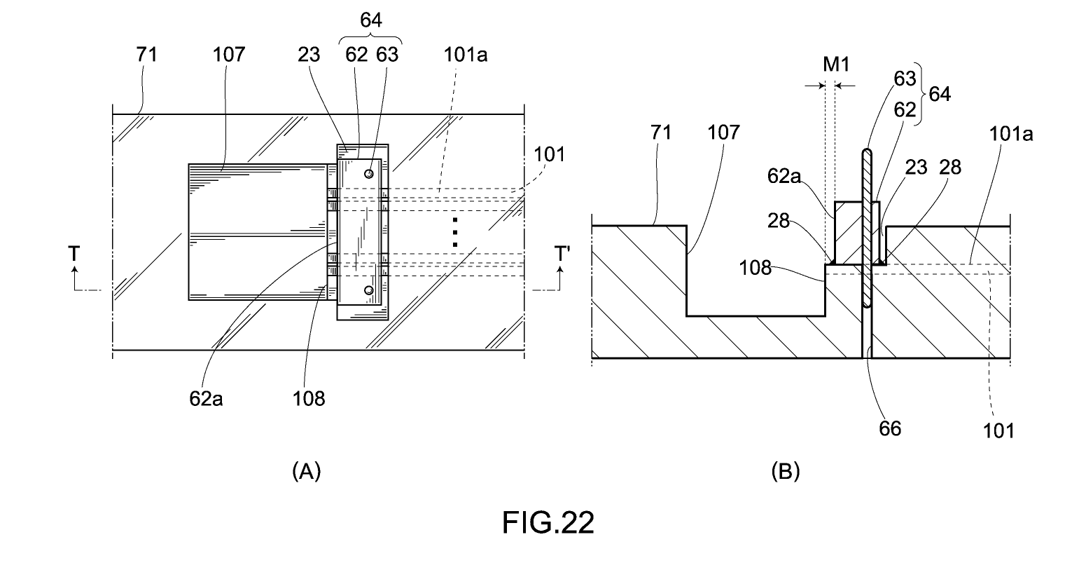

Next, as shown in FIG. 22(A) and FIG. 22(B) which is a sectional view taken on line T-T′ of FIG. 22(A), the guide pins 63 protruding from the lower end portion of the pin-equipped spacer 64 are inserted into the guide pin through holes 66 of the optical waveguide exposure section 23, thereby allowing the spacer main body 62 to be positioned to the peripheral surface portions 101a of the optical waveguides 101 exposed by the optical waveguide exposure section 23. The spacer main body 62 thus positioned is then fixed to the optical waveguide exposure section 23 by means of the joining material 28. Particularly, the spacer main body 62 is mounted in the optical waveguide exposure section 23 in the presence of the polishable margin M1.

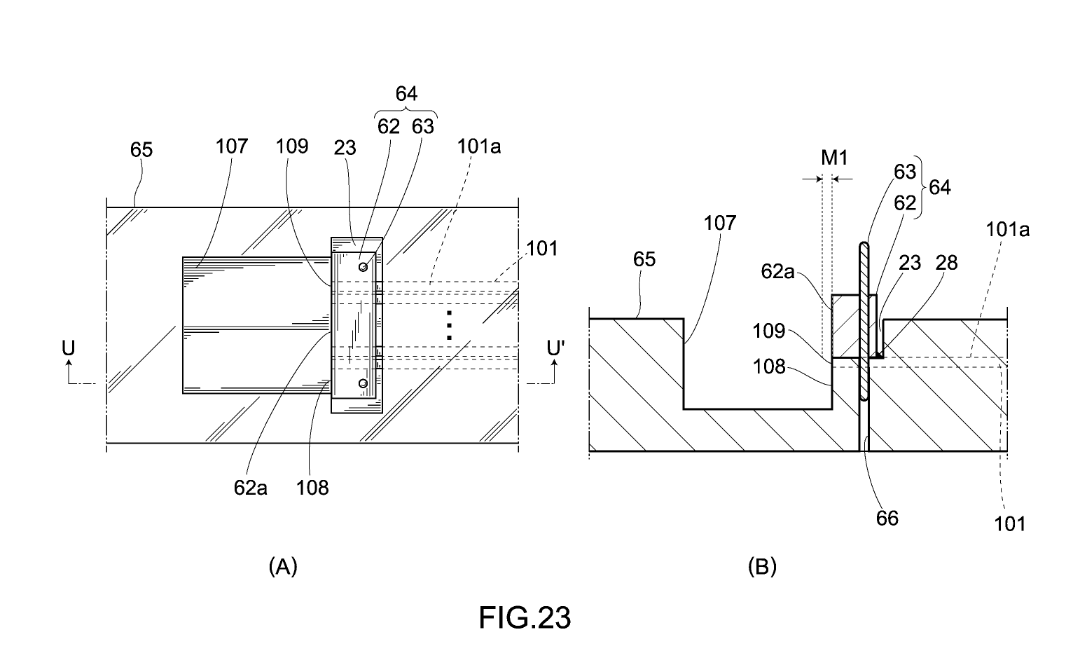

Next, as shown in FIG. 23(A) and FIG. 23(B) which is a sectional view taken on line U-U′ of FIG. 23(A), the polishable margin M1 located in an area adjacent to the side surface 62a of the spacer main body 62 is polished so as to form the optical waveguide end surfaces 109 on the side surface portion 108 of the concave section 107. As is the case in the second embodiment, the spacer main body 62 is made of a material harder than the materials of which the optical waveguides 101 and the base platform 65 are made. Accordingly, the spacer main body 62 is hardly polished during the polishing process, and is allowed to serve as a stopper since the side surface 62a thereof is not cut during the polishing process, thus allowing the optical waveguide end surfaces 109 to be formed on the same plane as that of the side surface 62a of the spacer main body 62.

Next, the guide pins 63 protruding from the upper end portion of the pin-equipped spacer 64 mounted on the base platform 65, are inserted through the guide pin through holes 67 bored on the optical module substrate 68, thereby allowing the optical module substrate 68 to be mounted on the base platform 65 and joined thereto by means of the joining material 117, thus completing manufacturing the signal transmission device 61 shown in FIG. 19(A) and FIG. 19(B).

According to the structure described above, the signal transmission device 61 comprises the spacer main body 62 interposed between the peripheral surface portions 101a of the optical waveguides 101 exposed by the optical waveguide exposure section 23, and the rear surface 69 of the optical module substrate 68. Particularly, the distance between the rear surface 69 of the optical module substrate 68 and the optical waveguides 101, is simply adjusted by the height of the spacer main body 62.

In this sense, according to the signal transmission device 61, the optical element 103 of the optical module substrate 68 can be positioned so high that it can actually face the optical waveguide end surfaces 109, by simply adjusting the height of the spacer main body 62 from the optical waveguides 101. Namely, according to the signal transmission device 61, the spacer main body 62 of a predetermined height allows the optical element 103 and the optical waveguide end surfaces 109 to face as well as be optically coupled with one another in the thickness direction z, even if a distance L2 between a surface 65a of the base platform 65 and the peripheral surface portions 101a of the optical waveguides 101 varies per production.

Further, according to the signal transmission device 61, the spacer main body 62 is made of a material harder than the materials of which the optical waveguides 101 and the base platform 65 are made. Accordingly, the side surface 62a of the spacer main body 62 is not cut during the polishing process for forming the optical waveguide end surfaces 109, thereby allowing the spacer main body 62 to serve as a stopper for restricting a polishable area, and thus allowing the optical waveguide end surfaces 109 to be formed on the same plane as that of the side surface 62a of the spacer main body 62. In this way, the signal transmission device 61 allows the optical waveguide end surfaces 109 to be precisely formed with respect to the side surface 62a of the spacer main body 62 in the polishing process, thus preventing a gap ΔL2 between the optical element 103 and the optical waveguide end surfaces 109 from varying per production.

Furthermore, according to the signal transmission device 61 of the fourth embodiment, the spacer main body 62 itself is equipped with the guide pins 63, thereby making it possible to precisely position the spacer main body 62 to the optical waveguide exposure section 23 by inserting the corresponding guide pins 63 into the guide pin through holes 66 bored in the optical waveguide exposure section 23. Accordingly, the signal transmission device 61 can allow the optical waveguide end surfaces 109 to be formed on the same plane as that of the side surface 62a of the spacer main body 62 through the polishing process. Namely, there can be precisely formed on the base platform 65 the optical waveguide end surfaces 109 with respect to the side surface 62a of the spacer main body 62.

Furthermore, according to the signal transmission device 61, the front ends of the guide pins 63 protrude from the upper end portion of the pin-equipped spacer 64 as well as the spacer main body 62, and are inserted through the guide pin through holes 67 of the optical module substrate 68, thereby allowing the optical module substrate 68 to be precisely positioned to the base platform 65. Accordingly, this signal transmission device 61 does not require guide pins independent from the pin-equipped spacer 64 to position the optical module substrate 68 to the base platform 65, thereby requiring no extra procedure other than mounting the corresponding spacer itself, thus simplifying the overall manufacturing procedure.

### (6) Fifth Embodiment

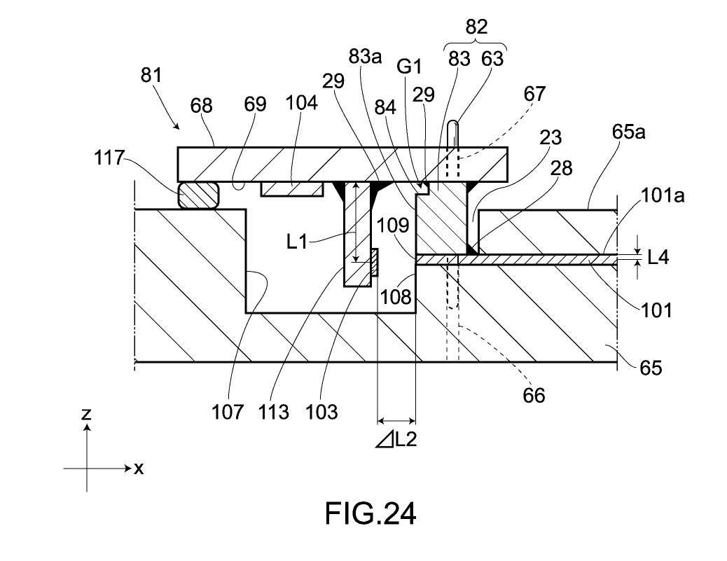

In FIG. 24, a symbol “81” represents a signal transmission device of a fifth embodiment of the present invention. Here, elements in FIG. 24 and corresponding elements in FIG. 19(B) share identical symbols. The signal transmission device of the fifth embodiment differs from the signal transmission device of the fourth embodiment in that a step portion 84 is formed on a spacer main body 83 of a pin-equipped spacer 82. Particularly, there is cut out from the spacer main body 83 a portion of a side surface 83a facing the supporting portion 113 and located in the vicinity of the rear surface 69 of the optical module substrate 68, thereby forming the thin-walled step portion 84. As a result, a receiving space G1 is formed by the step portion 84 thus formed on the spacer main body 83, such receiving space G1 serving to receive excessive portions of the joining material 29 protruding from joint locations at which the supporting portion 113 and the spacer main body 83 are joined to the optical module substrate 68.

The signal transmission device 81 having the aforementioned structure allows there to be achieved the same effects as those of the third embodiment and the fourth embodiment.

### (7) Other Embodiments

However, the present invention is not limited to the aforementioned embodiments. As a matter of fact, various modified embodiments are possible within the scope of the gist of the present invention. For example, other than the spacer employed in the first embodiment, there may also be used a pin-equipped spacer integrally comprising a spacer main body and guide pins, as described in the fourth embodiment.

Further, a receiving space is provided in the third embodiment and the fifth embodiment, by forming a step portion on a corresponding spacer. However, the present invention is not limited to such configuration. In fact, such receiving space may be variously formed into a concave section such as a curvature or the like provided on the corresponding spacer.

Furthermore, according to the fourth embodiment and the fifth embodiment, the guide pins 63 protrude from both the upper end portions and the lower end portions of the spacer main bodies 62, 83, thus allowing the spacer main bodies 62, 83 to be positioned to the base platform 65 and the optical module substrate 68. However, the present invention is not limited to these configurations. In fact, the guide pins may protrude from either one of the upper end portion and the lower end portion of the spacer main body so as allow the spacer main body to be positioned to either one of the base platform and the optical module substrate.

### DESCRIPTION OF THE SYMBOLS

1, 21, 31, 61, 81 signal transmission devices
2, 22, 65 base platforms
105, 68 optical module substrates
4, 24, 32 spacers
5, 23 optical waveguide exposure sections
64, 82 pin-equipped spacers (spacers)
63 guide pins
101 optical waveguides
103 optical element

1. A signal transmission device comprising:
a base platform including at least one optical waveguide formed internally, said optical waveguide having an end surface thereof exposed and allowing an optical signal to travel therethrough; and
an optical module substrate having a rear surface facing a surface of said base platform and having an optical element provided on said rear surface for transmitting or receiving the optical signal, said optical element facing and being optically coupled with the end surface-of said optical waveguide, wherein said base platform further includes:
an optical waveguide exposure section exposing a peripheral surface portion of said optical waveguide on said surface; and
a spacer interposed between the peripheral surface portion of said optical waveguide exposed by said optical waveguide exposure section and said rear surface of said optical module substrate, said spacer allowing said optical element to be positioned so high that said optical element can face the end surface of said optical waveguide.

2. The signal transmission device according to claim 1, wherein the peripheral surface portion of said optical waveguide formed internally in said base platform is unexposed in an area ranging from the end surface of said optical waveguide to said optical waveguide exposure section.

3. The signal transmission device according to claim 1, wherein said spacer is made of a material harder than materials forming said base platform and said optical waveguide, and the end surface of said optical waveguide is formed on a same plane as that of a side surface of said spacer.

4. The signal transmission device according to claim 3 further comprising:
a supporting portion supporting said optical element and joined, along with an upper portion of said spacer, to said rear surface of said optical module substrate through a joining material; and
a receiving space provided on the side surface of said spacer formed on a same plane as that of the end surface of said optical waveguide, said receiving space receiving excessive portions of the joining material protruding from joint locations of said supporting portion and said spacer.

5. The signal transmission device according to claim 1, wherein at least one of said base platform and said optical module substrate has one or more guide pin through holes bored thereon, and said spacer is provided with one or more guide pins inserted through said guide pin through holes of either said base platform or said optical module substrate so as to allow said spacer to be positioned to either said base platform or said optical module substrate.

6. A manufacturing method of a signal transmission device composed of: a base platform exposing an end surface(s) of at least one optical waveguide formed internally and allowing an optical signal to travel therethrough; and an optical module substrate having a rear surface facing a surface of said base platform and having an optical element provided on said rear surface for transmitting or receiving the optical signal, wherein the end surface of said optical waveguide and said optical element face and are optically coupled with each other,
said manufacturing method comprising:
an exposure section formation step for forming an optical waveguide exposure section exposing a peripheral surface portion of said optical waveguide on said surface of said base platform; and
a spacer mounting step for interposing a spacer between the peripheral surface portion of said optical waveguide exposed by said optical waveguide exposure section and the rear surface of said optical module substrate, said spacer allowing said optical element to be positioned so high that said optical element can face the end surface of said optical waveguide.

7. The manufacturing method of the signal transmission device according to claim 6, wherein said exposure section formation step allows the peripheral surface portion of said optical waveguide formed internally in said base platform to be unexposed in an area ranging from the end surface of said optical waveguide to said optical waveguide exposure section.

8. The manufacturing method of the signal transmission device according to claim 6 further comprising a processing step following said spacer mounting step, for forming the end surface of said optical waveguide on a same plane as that of a side surface of said spacer, said spacer mounted in said spacer mounting step being made of a material harder than materials forming said base platform and said optical waveguide.

9. The manufacturing method of the signal transmission device according to claim 8, wherein said spacer mounted in said spacer mounting step has a receiving space formed on the side surface thereof provided on a same plane as that of the end surface of said optical waveguide, said receiving space receiving excessive portions of a joining material protruding from joint locations of a supporting portion supporting said optical element and said spacer when said supporting portion and an upper portion of said spacer are joined to the rear surface of said optical module substrate through the joining material.

10. The manufacturing method of the signal transmission device according to claim 6 further comprising a boring step prior to said spacer mounting step, for boring one or more guide pin through holes on at least one of said base platform and said optical module substrate, said spacer mounting step mounting said spacer having one or more guide pins capable of being inserted through said guide pin through holes of either said base platform or said optical module substrate, thus allowing said spacer to be positioned to said base platform or said optical module substrate through said guide pins in said spacer mounting step.

11. The signal transmission device according to claim 2, wherein at least one of said base platform and said optical module substrate has one or more guide pin through holes bored thereon, and said spacer is provided with one or more guide pins inserted through said guide pin through holes of either said base platform or said optical module substrate so as to allow said spacer to be positioned to either said base platform or said optical module substrate.

12. The signal transmission device according to claim 3, wherein at least one of said base platform and said optical module substrate has one or more guide pin through holes bored thereon, and said spacer is provided with one or more guide pins inserted through said guide pin through holes of either said base platform or said optical module substrate so as to allow said spacer to be positioned to either said base platform or said optical module substrate.

13. The signal transmission device according to claim 4, wherein at least one of said base platform and said optical module substrate has one or more guide pin through holes bored thereon, and said spacer is provided with one or more guide pins inserted through said guide pin through holes of either said base platform or said optical module substrate so as to allow said spacer to be positioned to either said base platform or said optical module substrate.

14. The manufacturing method of the signal transmission device according to claim 7 further comprising a boring step prior to said spacer mounting step, for boring one or more guide pin through holes on at least one of said base platform and said optical module substrate, said spacer mounting step mounting said spacer having one or more guide pins capable of being inserted through said guide pin through holes of either said base platform or said optical module substrate, thus allowing said spacer to be positioned to said base platform or said optical module substrate through said guide pins in said spacer mounting step.

15. The manufacturing method of the signal transmission device according to claim 8 further comprising a boring step prior to said spacer mounting step, for boring one or more guide pin through holes on at least one of said base platform and said optical module substrate, said spacer mounting step mounting said spacer having one or more guide pins capable of being inserted through said guide pin through holes of either said base platform or said optical module substrate, thus allowing said spacer to be positioned to said base platform or said optical module substrate through said guide pins in said spacer mounting step.

16. The manufacturing method of the signal transmission device according to claim 9 further comprising a boring step prior to said spacer mounting step, for boring one or more guide pin through holes on at least one of said base platform and said optical module substrate, said spacer mounting step mounting said spacer having one or more guide pins capable of being inserted through said guide pin through holes of either said base platform or said optical module substrate, thus allowing said spacer to be positioned to said base platform or said optical module substrate through said guide pins in said spacer mounting step.
